(19) United States
(12) Patent Application Publication
(10) Pub. No.: US 2023/0169280 A1
(43) Pub. Date: Jun. 1, 2023

(54) INFORMATION PROCESSING APPARATUS AND INFORMATION PROCESSING METHOD

(71) Applicant: SONY GROUP CORPORATION, TOKYO (JP)

(72) Inventor: KANAKO WATANABE, TOKYO (JP)

(21) Appl. No.: 17/920,175

(22) PCT Filed: Mar. 31, 2021
(86) PCT No.: PCT/JP2021/013757

§ 371 Date: Oct. 20, 2022

(30) Foreign Application Priority Data
Apr. 30, 2020 (JP) 2020-080864

(51) Int. Cl. G06F 40/56; G06V 30/18; G06V 30/19; G10L 15/26

(52) U.S. Cl. CPC G06F 40/56; G06V 30/18; G06V 30/19093; G10L 15/26

(57) ABSTRACT

A server device (10) corresponding to an example of an information processing apparatus includes an acquisition unit (13a) that acquires a text regarding a remark of a user who has refrained from sending the remark, an input text analysis unit (13b) (corresponding to an example of the “first analysis unit”) that analyzes the text regarding the remark acquired by the acquisition unit (13a) by a natural language process, a past information analysis unit (13c) (corresponding to an example of the “second analysis unit”) that analyzes past information about a content of the remark by the natural language process, and a generation unit (13e) that generates a candidate for the remark text sent by the user so that there is no contradiction with the past information based on a comparison between respective analysis results of the input text analysis unit (13b) and the past information analysis unit (13c).

### FIELD

The present disclosure relates to an information processing apparatus and an information processing method.

### BACKGROUND

In recent years, with the spread of smartphones, a social networking service (SNS), and the like, not only people who have great influence such as famous people, statesmen, and companies but also ordinary people have an increased opportunity to remark in public. Furthermore, there are increasing cases in which an account of a fictitious existence such as a character or a Vtuber is created on an SNS, and the remark content is managed by a performer or a person in charge of a company mainly for the purpose of promotion or communication with fans.

Under such circumstances, when inappropriate remarks are made, for example, on an SNS, a press conference, or the like, there is a possibility that charges or libels will concentrate (so-called “burn”) on the Internet, for example. In contrast, in the related art, measures have been mainly taken by human power, such as self-determination of the speaker himself/herself or the account operator and preparation of a question and answer collection.

However, it goes without saying that there is a limit to countermeasures by human power. Therefore, in such a situation, for example, it is conceivable to use a technique or the like for automatically determining a fixed response using the natural language process (see, for example, Patent Literature 1.).

### CITATION LIST

### Patent Literature

Patent Literature 1: JP 2018-516397 W

### SUMMARY

### Technical Problem

However, the above-described conventional technology has room for further improvement in assisting a user to remark more safely in an opportunity of remarking in a public place.

Specifically, the above-described conventional technique is merely a technique for passively returning a response, and thus, for example, it is not possible to prevent unexpected inappropriate remark or the like at an opportunity of a voluntary remark.

Therefore, the present disclosure proposes an information processing apparatus and an information processing method capable of assisting a user to remark more safely on a public occasion.

### Solution to Problem

According to the present disclosure, an information processing apparatus includes an acquisition unit that acquires a text regarding a remark of a user who has refrained from sending the remark, a first analysis unit that analyzes the text regarding the remark acquired by the acquisition unit by a natural language process, a second analysis unit that analyzes past information about a content of the remark by the natural language process, and a generation unit that generates a candidate for the remark text sent by the user so that there is no contradiction with the past information based on a comparison between respective analysis results of the first analysis unit and the second analysis unit.

According to the present disclosure, an information processing method includes acquiring a text related to a remark of a user who has refrained from sending the remark, analyzing the text related to the remark acquired by the acquiring by a natural language process, analyzing past information about a content of the remark by the natural language process, and generating a candidate for a remark text sent by the user so that there is no contradiction between the candidate and the past information based on a comparison between respective analysis results of analyzing the text related to the remark and analyzing the past information.

### BRIEF DESCRIPTION OF DRAWINGS

FIG. 1 is a schematic explanatory diagram of an information processing method according to a first embodiment.

FIG. 2 is a diagram illustrating a configuration example of an information processing system according to the first embodiment.

FIG. 3 is a block diagram illustrating a configuration example of a server device according to the first embodiment.

FIG. 4 is a block diagram illustrating a configuration example of an input text analysis unit according to the first embodiment.

FIG. 5 is a block diagram illustrating a configuration example of a past information analysis unit according to the first embodiment.

FIG. 6 is a block diagram illustrating a configuration example of a contradiction degree determination unit according to the first embodiment.

FIG. 7 is a block diagram illustrating a configuration example of a generation unit according to the first embodiment.

FIG. 8 is an explanatory diagram (part 1) of a specific example #1 of information processing according to the first embodiment.

FIG. 9 is an explanatory diagram (part 2) of the specific example #1 of information processing according to the first embodiment.

FIG. 10 is an explanatory diagram (part 1) of a specific example #2 of information processing according to the first embodiment.

FIG. 11 is an explanatory diagram (part 2) of the specific example #2 of information processing according to the first embodiment.

FIG. 12 is an explanatory diagram (part 3) of the specific example #2 of information processing according to the first embodiment.

FIG. 13 is an explanatory diagram (part 1) of a specific example #3 of information processing according to the first embodiment.

FIG. 14 is an explanatory diagram (part 2) of the specific example #3 of information processing according to the first embodiment.

FIG. 15 is an explanatory diagram (part 1) of a specific example #4 of information processing according to the first embodiment.

FIG. 16 is an explanatory diagram (part 2) of the specific example #4 of information processing according to the first embodiment.

FIG. 17 is an explanatory diagram of a specific example #5 of information processing according to the first embodiment.

FIG. 18 is an explanatory diagram of a specific example #6 of information processing according to the first embodiment.

FIG. 19 is a diagram (part 1) illustrating a pattern of a contradiction degree determination result.

FIG. 20 is a diagram (part 2) illustrating a pattern of a contradiction degree determination result.

FIG. 21 is a diagram (part 3) illustrating a pattern of a contradiction degree determination result.

FIG. 22 is an explanatory diagram (part 1) of a specific example #7 of information processing according to the first embodiment.

FIG. 23 is an explanatory diagram (part 2) of the specific example #7 of information processing according to the first embodiment.

FIG. 24 is an explanatory diagram (part 1) of a specific example #8 of information processing according to the first embodiment.

FIG. 25 is an explanatory diagram (part 2) of the specific example #8 of information processing according to the first embodiment.

FIG. 26 is an explanatory diagram (part 3) of the specific example #8 of information processing according to the first embodiment.

FIG. 27 is a flowchart (part 1) illustrating a processing procedure executed by a server device according to the first embodiment.

FIG. 28 is a flowchart (part 2) illustrating a processing procedure executed by the server device according to the first embodiment.

FIG. 29 is a diagram illustrating a display screen example of information processing according to the first embodiment.

FIG. 30 is an explanatory diagram (part 1) of a first modification.

FIG. 31 is an explanatory diagram (part 2) of the first modification.

FIG. 32 is a block diagram illustrating a configuration example of a generation unit according to a second modification.

FIG. 33 is a flowchart illustrating a processing procedure executed by a server device according to the second modification.

FIG. 34 is a block diagram illustrating a configuration example of a storage unit of a server device according to the second embodiment.

FIG. 35 is a diagram illustrating an example of competitor information.

FIG. 36 is a block diagram illustrating a configuration example of a past information analysis unit of a server device according to the second embodiment.

FIG. 37 is a block diagram illustrating a configuration example of a contradiction degree determination unit of a server device according to the second embodiment.

FIG. 38 is a block diagram illustrating a configuration example of a generation unit of a server device according to the second embodiment.

FIG. 39 is a diagram illustrating a display screen example of information processing according to the second embodiment.

FIG. 40 is a block diagram illustrating a configuration example of a server device according to a third embodiment.

FIG. 41 is a block diagram illustrating a configuration example of a generation unit of a server device according to the third embodiment.

FIG. 42 is a flowchart illustrating a processing procedure executed by the server device according to the third embodiment.

FIG. 43 is a diagram illustrating a display screen example of information processing according to the third embodiment.

FIG. 44 is a diagram illustrating a presentation example of information processing by audio reproduction according to the third embodiment.

FIG. 45 is an explanatory diagram in a case where there is a plurality of responders.

FIG. 46 is a hardware configuration diagram illustrating an example of a computer that implements functions of a server device.

### DESCRIPTION OF EMBODIMENTS

Hereinafter, the embodiments of the present disclosure will be described in detail with reference to the drawings. In the following embodiments, the same parts are denoted by the same reference signs, and a duplicate description will be omitted.

In addition, in the present specification and the drawings, a plurality of components having substantially the same functional configuration may be distinguished by attaching different hyphenated numerals after the same reference numerals. For example, a plurality of configurations having substantially the same functional configuration is distinguished as a terminal device 100-1 and a terminal device 100-2 as necessary. However, when it is not necessary to distinguish each of the plurality of components having substantially the same functional configurations, only the same reference signs are given. For example, in a case where it is not necessary to particularly distinguish the terminal device 100-1 and the terminal device 100-2, they are simply referred to as a terminal device 100.

In addition, in the following, a first embodiment and a second embodiment will be described by exemplifying a posting scene on an SNS for which real-time property is not required, and a third embodiment will be described by exemplifying a scene of an answer in a press conference, an interview, or the like for which real-time property is required.

Further, the present disclosure will be described in the order of the following items.

1. Outline of information processing method according to first embodiment

2. Configuration of information processing system according to first embodiment]

2-1. Overall configuration

2-2. Configuration of server device

2-3. Specific example #1 of information processing according to first embodiment

2-4. Specific example #2 of information processing according to first embodiment

2-5. Specific example #3 of information processing according to first embodiment

2-6. Specific example #4 of information processing according to first embodiment

2-7. Specific example #5 of information processing according to first embodiment

2-8. Specific example #6 of information processing according to first embodiment

2-9. Specific example #7 of information processing according to first embodiment

2-10. Specific example #8 of information processing according to first embodiment

2-11. Processing procedure of information processing according to first embodiment

2-12. Display screen example of information processing according to first embodiment

3. Modification of first embodiment

3-1. First modification

3-2. Second modification

4. Summary of first embodiment

5. Outline of information processing method according to second embodiment

6. Configuration of information processing system according to second embodiment

7. Summary of second embodiment

8. Outline of third embodiment

9. Configuration of information processing system according to third embodiment

9-1. Configuration of server device and other devices

9-2. Specific example of information processing according to third embodiment

10. Summary of third embodiment

11. Other modifications

12. Hardware configuration

13. Conclusion

### First Embodiment

<<1. Overview of Information Processing Method According to First Embodiment>>

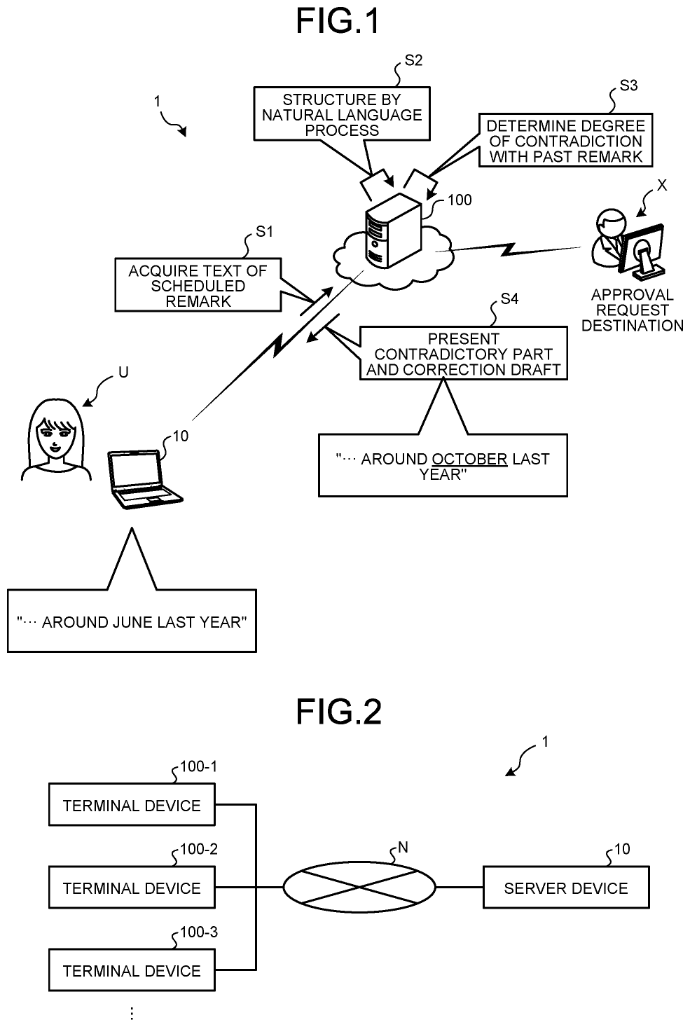

First, an outline of an information processing method according to the first embodiment will be described with reference to FIG. 1. FIG. 1 is a schematic explanatory diagram of an information processing method according to a first embodiment.

An information processing method according to the first embodiment of the present disclosure includes acquiring a text related to the remark of the user who has refrained from sending the remark, analyzing the acquired text related to the remark by the natural language process, analyzing past information related to the content of the remark by the natural language process, and generating a candidate for the remark text sent by the user so that there is no contradiction with the past information based on a comparison between respective analysis results of an analysis of the text related to the remark and an analysis of the past information.

Specifically, as illustrated in FIG. 1, first, it is assumed that a user U is scheduled to post, for example, a remark including the phrase “ . . . around June last year” on the SNS using a terminal device 100 used by the user U. In such a case, the user U can determine, almost only by his own memory, whether the text of a scheduled remark is inappropriate, for example, contradictory to the past remark. The information processing method according to the first embodiment assists the user U to remark more safely in such a case.

More specifically, in the information processing method according to the first embodiment, first, in a case where there is a text of a remark scheduled to be made by the user U, a server device 10 acquires the text of the scheduled remark (step S1). The server device 10 is, for example, a server that provides an SNS.

Then, the server device 10 structures the acquired text of a scheduled remark by the natural language process (step S2). Then, the server device 10 determines the degree of contradiction with the past remark of the user U based on the structured information (step S3).

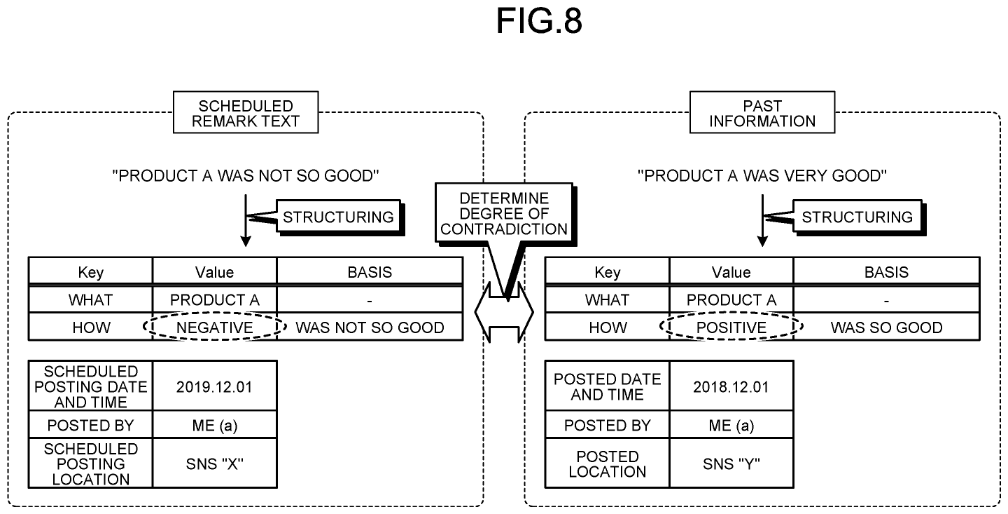

Note that the past information about the user U including the past remark is periodically crawled by the server device 10, structured, and held in the server device 10. The server device 10 executes step S3 based on the held information. The specific content of step S3 will be described later with reference to FIG. 8 and the like.

Then, in a case where there is a contradiction as a result of executing step S3, the server device 10 presents the contradictory part and the correction draft to the user U (step S4). In the example of FIG. 1, there is a contradiction in the part of “June” in the text of a scheduled remark, and as indicated by an underlined part, it is indicated that a correction draft in which it should be corrected to “October” is presented to the user U.

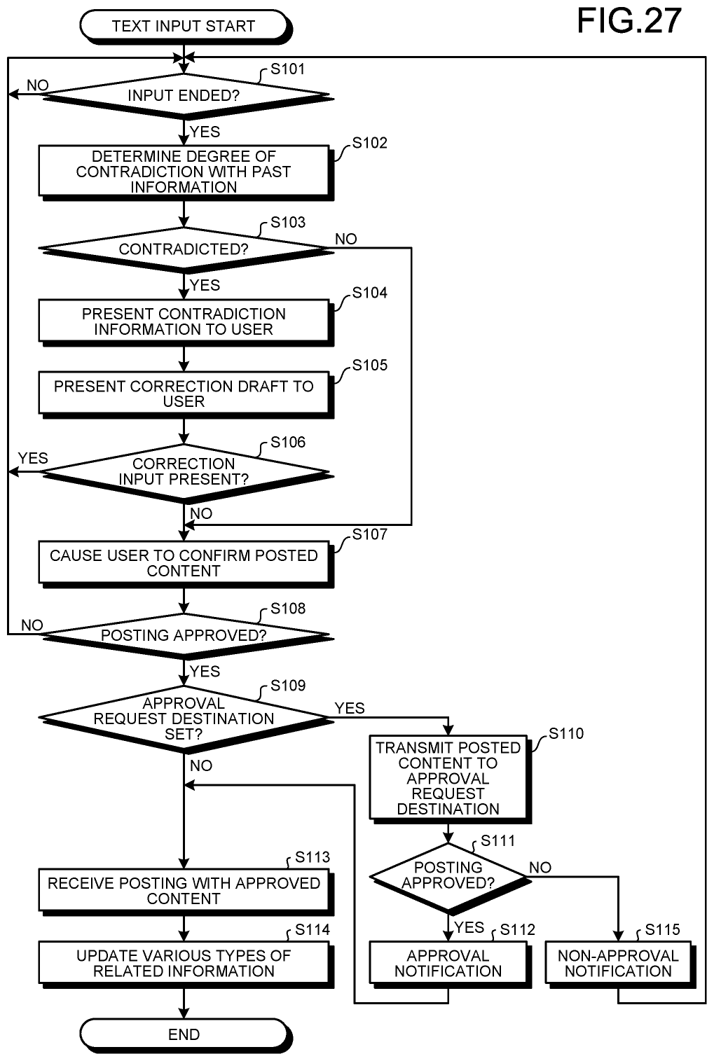

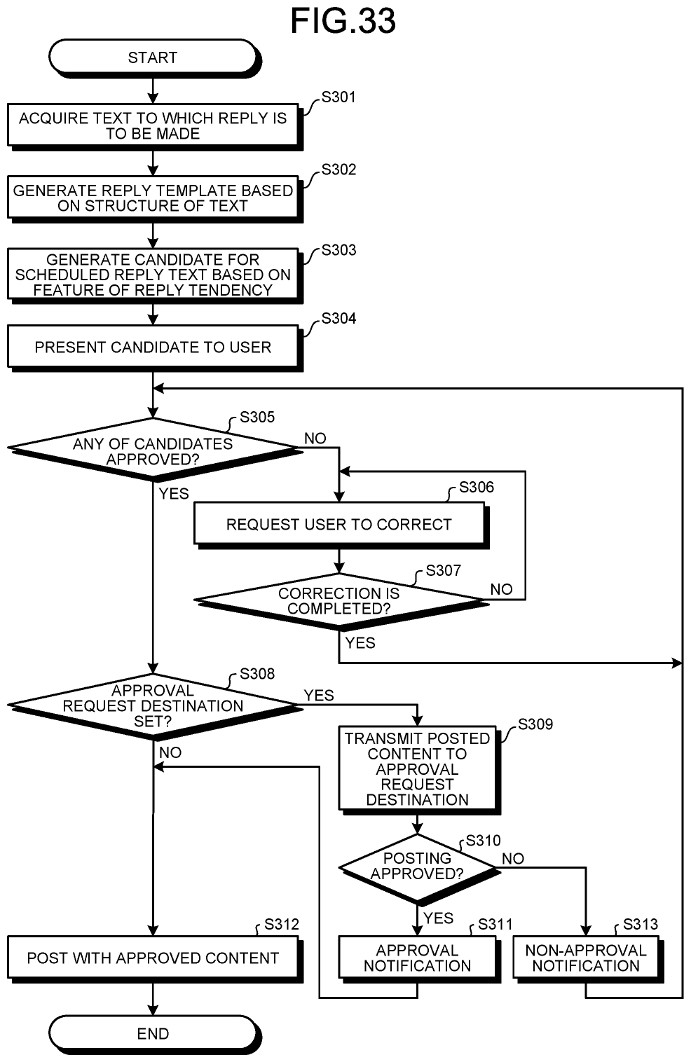

The user U corrects the text of a scheduled remark based on the information presented in step S4 and then posts the text to the SNS, so that the user U can make a safe remark that does not contradict his/her past remark. Note that, in a case where the user U is, for example, popular icon or the like, as illustrated in FIG. 1, another person such as a manager may be set as the approval request destination “approver X” so as to approve the remark of the user U. Such a case will be described later with reference to FIGS. 27 and 33.

As described above, an information processing method according to the first embodiment includes acquiring a text related to the remark of the user U who has refrained from sending the remark, analyzing the acquired text related to the remark by the natural language process, analyzing past information related to the content of the remark by the natural language process, and generating a candidate for the remark text sent by the user U so that there is no contradiction with the past information based on a comparison between respective analysis results of an analysis of the text related to the remark and an analysis of the past information.

Therefore, according to the information processing method according to the embodiment, it is possible to assist the user U to remark more safely in an opportunity to remark in a public place.

Hereinafter, a configuration example of the information processing system 1 to which the information processing method according to the first embodiment described above is applied will be described more specifically.

<<2. Configuration of Information Processing System According to First Embodiment>>

### 2-1. Overall Configuration

FIG. 2 is a diagram illustrating a configuration example of an information processing system 1 according to the first embodiment. As illustrated in FIG. 1, the information processing system 1 includes a server device 10 and one or more terminal devices 100. Furthermore, as illustrated in FIG. 2, the server device 10 and the terminal device 100 are connected to each other by a network N such as the Internet or a mobile phone network to transmit and receive data to and from each other via the network N.

The server device 10 is configured as, for example, a cloud server that provides an SNS, and when posted information including a remark content of the user U is posted from a terminal device 100, the server device manages the posted information so that the posted information can be acquired and browsed.

Furthermore, the server device 10 acquires the text of a remark scheduled to be made by the user U from the terminal device 100 and structures the text. Furthermore, the server device 10 compares the structured information with the past information about the user U to determine the degree of contradiction. Furthermore, in a case where there is a contradiction, the server device 10 presents the contradictory part and the correction draft to the user U.

The terminal device 100 is an information device used by the user U, and the user U inputs a remark content via the terminal device 100 to transmit the remark content to the server device 10. The terminal device 100 is, for example, a desktop personal computer (PC), a notebook PC, a tablet terminal, a mobile phone including a smartphone, a personal digital assistant (PDA), or the like. Furthermore, the terminal device 100 may be, for example, a wearable terminal worn by the user U.

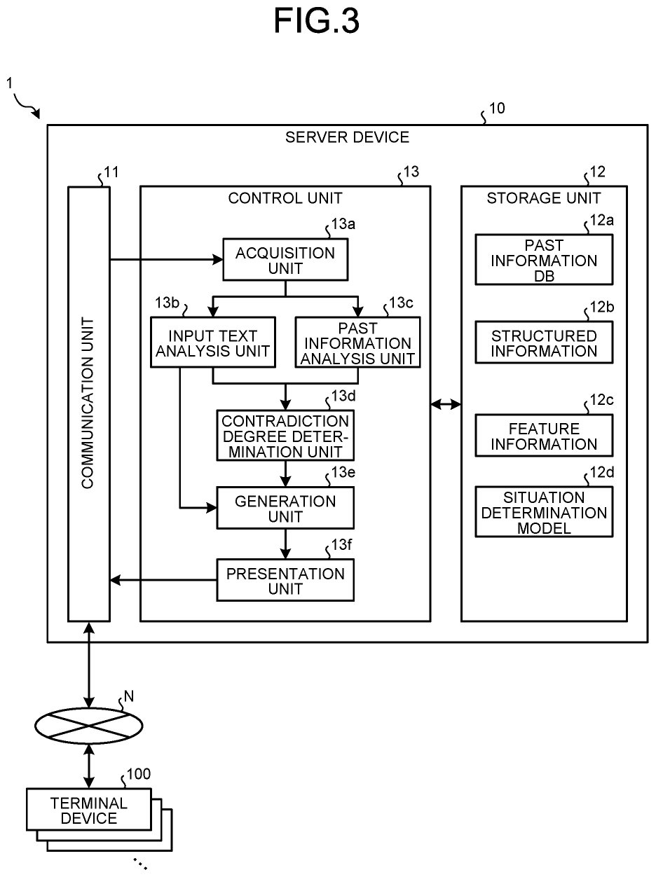

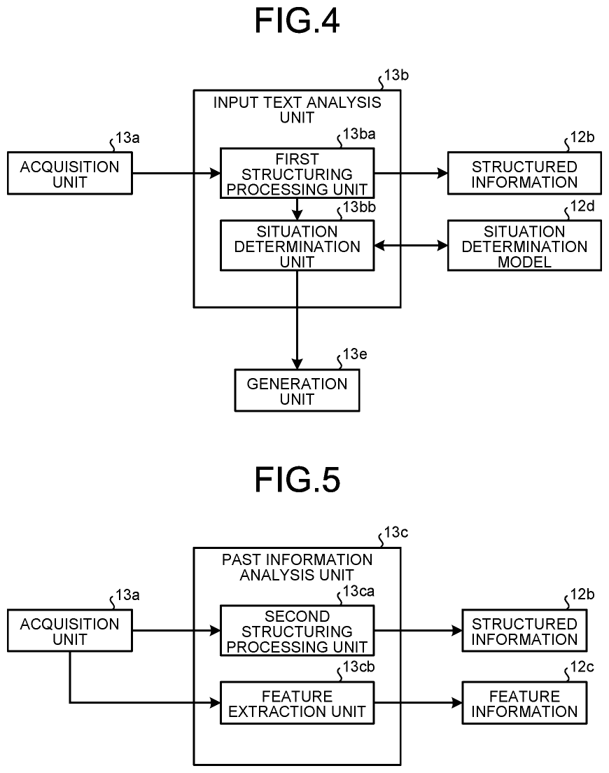

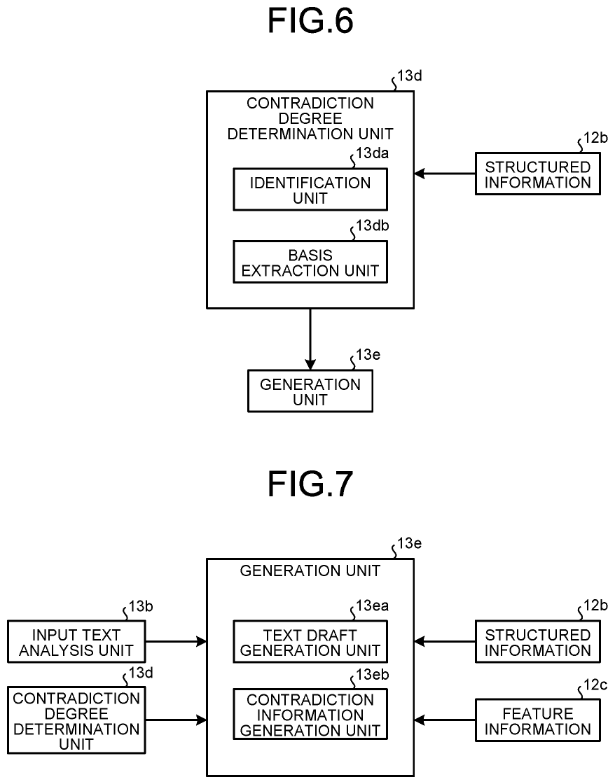

Next, FIG. 3 is a block diagram illustrating a configuration example of the server device 10 according to the first embodiment. FIG. 4 is a block diagram illustrating a configuration example of an input text analysis unit 13b according to the first embodiment. FIG. 5 is a block diagram illustrating a configuration example of a past information analysis unit 13c according to the first embodiment. FIG. 6 is a block diagram illustrating a configuration example of a contradiction degree determination unit 13d according to the first embodiment. FIG. 7 is a block diagram illustrating a configuration example of a generation unit 13e according to the first embodiment.

Note that, in FIGS. 3 to 7 (and FIGS. 32, 36 to 38, 40, and 41 illustrated later), only components necessary for describing features of the embodiment are illustrated, and descriptions of general components are omitted.

In other words, each component illustrated in FIGS. 3 to 7 (and FIGS. 32, 36 to 38, 40, and 41) is functionally conceptual, and does not necessarily have to be physically configured as illustrated. For example, a specific form of distribution and integration of each block is not limited to the illustrated form, and all or part thereof can be functionally or physically distributed and integrated in an any unit according to various loads, usage conditions, and the like.

In the description using FIGS. 3 to 7 (and FIGS. 32, 36 to 38, 40, and 41), the description of the already described components may be simplified or omitted.

### 2-2. Configuration of Server Device

As illustrated in FIG. 3, the server device 10 includes a communication unit 11, a storage unit 12, and a control unit 13. The communication unit 11 is realized by, for example, a network interface card (NIC) or the like. The communication unit 11 is wirelessly or wiredly connected to the terminal device 100 via the network N to transmit and receives information to and from the terminal device 100.

The storage unit 12 is realized by, for example, a semiconductor memory device such as a random access memory (RAM), a read only memory (ROM), or a flash memory, or a storage device such as a hard disk or an optical disk. In the example illustrated in FIG. 3, the storage unit 12 stores a past information database (DB) 12a, structured information 12b, feature information 12c, and a situation determination model 12d.

The past information DB 12a is a database of past information about the user U acquired by being periodically crawled by an acquisition unit 13a to be described later. The past information about the user U includes information about the past behavior of the user U, such as remarks posted by the user U on one or more SNSs in the past. Furthermore, the past information about the user U includes information, about the past behavior of the user U, in which anyone/anything other than the user U are information sources, such as a remark, referring to the user U, posted in the past by an account other than the user U.

The structured information 12b is information after the scheduled remark text is subjected to the natural language process by the input text analysis unit 13b to be described later and structured. Furthermore, the structured information 12b is information after the past remark text and the like are subjected to the natural language process by the past information analysis unit 13c to be described later and structured.

The feature information 12c is information about the feature of the user U based on the past remark text of the user U himself/herself extracted by the past information analysis unit 13c.

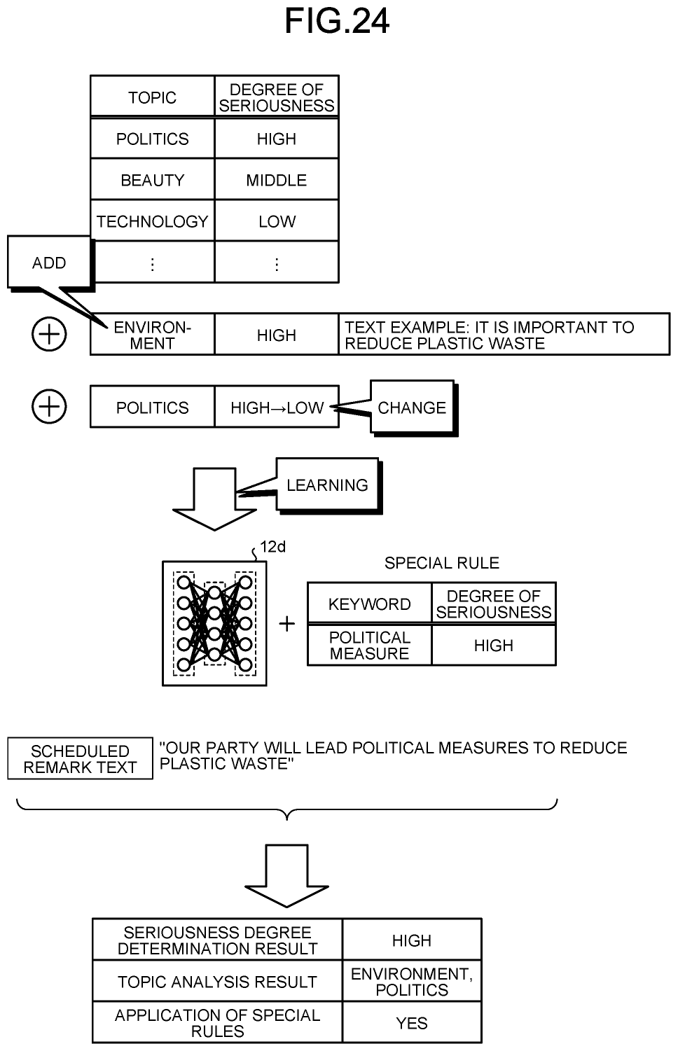

The situation determination model 12d is a determination model for determining the situation, particularly the degree of seriousness, indicated by the scheduled remark text when the user U remarks, and is used by a situation determination unit 13bb to be described later. The situation determination model 12d is generated by learning using a neural network or the like based on a preset degree of seriousness for each topic. Furthermore, the situation determination model 12d is relearned as appropriate in a case where the degree of seriousness is manually corrected, a topic is added, or the like. More specifically, this will be described later with reference to FIG. 24.

The control unit 13 is a controller, and is implemented by, for example, a central processing unit (CPU), a micro processing unit (MPU), or the like executing various programs stored in the storage unit 12 using a RAM as a work area. Furthermore, the control unit 13 can be realized by, for example, an integrated circuit such as an application specific integrated circuit (ASIC) or a field programmable gate array (FPGA).

The control unit 13 includes the acquisition unit 13a, the input text analysis unit 13b, the past information analysis unit 13c, the contradiction degree determination unit 13d, the generation unit 13e, and a presentation unit 13f, and realizes or executes a function and an action of information processing described below.

The acquisition unit 13a acquires various types of information via the communication unit 11. For example, the acquisition unit 13a periodically crawls on the Internet, acquires past information about the past of the user U, and registers the past information in the past information DB 12a.

Furthermore, for example, the acquisition unit 13a acquires the scheduled remark text of the user U from the terminal device 100 to output the text to the input text analysis unit 13b.

Furthermore, for example, when acquiring new past information about the user U and registering the past information in the past information DB 12a, the acquisition unit 13a causes the past information analysis unit 13c to analyze the past information.

The input text analysis unit 13b performs the natural language process on the scheduled remark text of the user U acquired by the acquisition unit 13a to structure, and registers the structured information in the structured information 12b. In addition, the input text analysis unit 13b determines the degree of seriousness of the scheduled remark text using the situation determination model 12d.

More specifically, as illustrated in FIG. 4, the input text analysis unit 13b includes a first structuring processing unit 13ba and a situation determination unit 13bb.

The first structuring processing unit 13ba structures the scheduled remark text of the user U acquired by the acquisition unit 13a by performing the natural language process using an algorithm such as natural language understanding (NLU). In addition, the first structuring processing unit 13ba registers the structured information in the structured information 12b, and causes the situation determination unit 13bb to determine the degree of seriousness by using the structured information.

The situation determination unit 13bb determines the degree of seriousness of the scheduled remark text of the user U using the situation determination model 12d based on the structured information structured by the first structuring processing unit 13ba. In addition, the situation determination unit 13bb outputs the determined degree of seriousness to the generation unit 13e.

The description returns to FIG. 3. The past information analysis unit 13c performs the natural language process on the past remark text of the user U himself/herself or the past remark text that is mentioned about the user U by anyone/anything other than the user U, acquired by the acquisition unit 13a, to structure the text, and registers the structured information in the structured information 12b. Furthermore, the past information analysis unit 13c extracts the feature of the user U based on the past remark text of the user U.

More specifically, as illustrated in FIG. 5, the past information analysis unit 13c includes a second structuring processing unit 13ca and a feature extraction unit 13cb.

The second structuring processing unit 13ca performs the natural language process on the past remark text of the user U himself/herself or the past remark text in which anyone/anything other than the user U refers to the user U, which is acquired by the acquisition unit 13a, by an algorithm such as NLU to structure the text. In addition, the second structuring processing unit 13ca registers the structured information in the structured information 12b.

The feature extraction unit 13cb extracts the feature of the user U based on the past remark text of the user U himself/herself acquired by the acquisition unit 13a, and registers the feature in the feature information 12c.

The description returns to FIG. 3. The contradiction degree determination unit 13d determines a degree of contradiction between the scheduled remark text and the past information of the user U based on the structured information 12b. In addition, in a case where there is a contradiction, the contradiction degree determination unit 13d identifies a contradictory part. Further, when there is a contradiction, the contradiction degree determination unit 13d extracts a basis thereof.

More specifically, as illustrated in FIG. 6, contradiction degree determination unit 13d includes an identification unit 13da and a basis extraction unit 13db. The identification unit 13da determines the degree of contradiction between the scheduled remark text and the past information of the user U based on the structured information 12b, and in a case where there is a contradiction, identifies the contradictory part. The identification unit 13da outputs the identified contradictory part to the generation unit 13e.

The basis extraction unit 13db extracts the bases of the contradictory parts identified by the identification unit 13da to output information serving as the extracted bases to the generation unit 13e.

The description returns to FIG. 3. Based on the information output by the input text analysis unit 13b, the information output by the contradiction degree determination unit 13d, the structured information 12b, and the feature information 12c, the generation unit 13e generates the correction draft and contradiction information about the contradiction of the scheduled remark text to be presented to the user U.

More specifically, as illustrated in FIG. 7, the generation unit 13e includes a text draft generation unit 13ea and a contradiction information generation unit 13eb. The text draft generation unit 13ea generates a correction draft of the scheduled remark text based on the scheduled remark text output from the input text analysis unit 13b, the degree of seriousness, the contradictory part output from the contradiction degree determination unit 13d, the structured information 12b, and the feature information 12c.

The contradiction information generation unit 13eb generates the contradiction information based on the information about the contradictory part and the basis output from the contradiction degree determination unit 13d.

The description returns to FIG. 3. In addition, the generation unit 13e outputs the generated information to the presentation unit 13f. The presentation unit 13f transmits the information generated by the generation unit 13e, that is, the correction draft and the contradiction information of the scheduled remark text to the terminal device 100 via the communication unit 11 to present the information to the user U.

### 2-3. Specific Example #1 of Information Processing According to First Embodiment

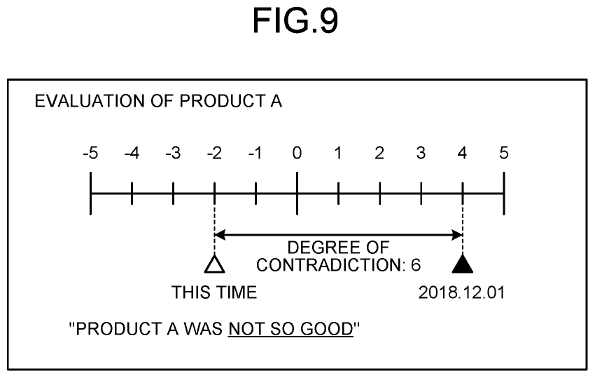

Next, a specific example #1 of the information processing according to the first embodiment will be described with reference to FIGS. 8 and 9 while giving a specific example of the scheduled remark text of the user U. FIG. 8 is an explanatory diagram (part 1) of the specific example #1 of information processing according to the first embodiment. Furthermore, FIG. 9 is an explanatory diagram (part 2) of a specific example #1 of information processing according to the first embodiment.

As illustrated in FIG. 8, it is assumed that the scheduled remark text of the user U (account “a”) is “Product A was not so good”. The input text analysis unit 13b performs structuring on the scheduled remark text as illustrated on the left side of the figure.

On the other hand, the past information analysis unit 13c performs structuring as illustrated on the right side of the figure on the past remark text “Product A was very good” of the user U regarding the same Product A.

Then, the contradiction degree determination unit 13d compares these pieces of structured information to determine the degree of contradiction. Here, as illustrated in the figure, although the user U affirmatively remarks that the product A “was very good” in the past information, the user U negatively remarks “was not so good” in the scheduled remark text.

That is, as illustrated in a portion surrounded by a closed curve of a broken line in the figure, there is a considerable difference in the evaluation level between the past information and the scheduled remark text with “positive” and “negative” for the same product A. Therefore, in such a case, the contradiction degree determination unit 13d determines that there is a contradiction. That is, the contradiction degree determination unit 13d calculates a difference between the evaluation values, for the same object, included in respective analysis results of the input text analysis unit 13b and the past information analysis unit 13c, and determines that there is a contradiction when the difference is a predetermined amount or more.

Then, the presentation unit 13f presents contradiction information generated by the generation unit 13e in an example as illustrated in FIG. 9 to the user U, for example. In this example, the current and past evaluation levels by the user U are disposed on the level axis, and the degree of contradiction, which is the difference between the evaluation levels, is clearly indicated. In addition, this is an example in which a contradictory part of “was not so good” is visualized with an underline.

### 2-4. Specific Example #2 of Information Processing According to First Embodiment

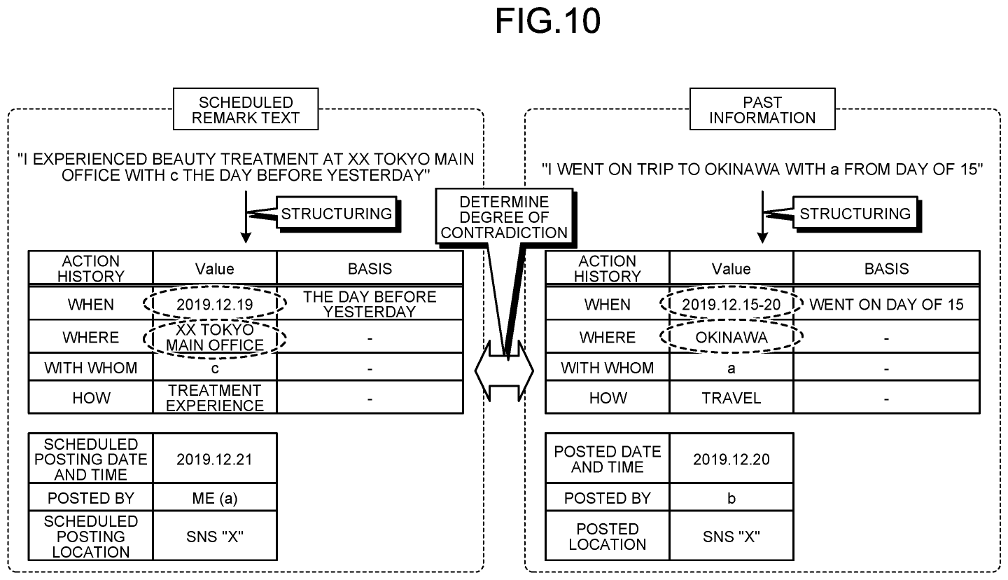

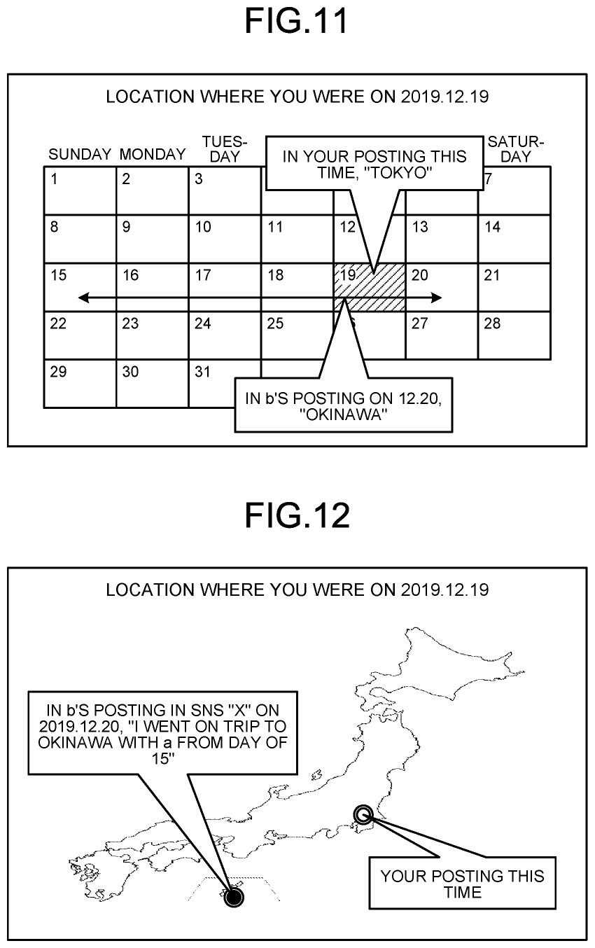

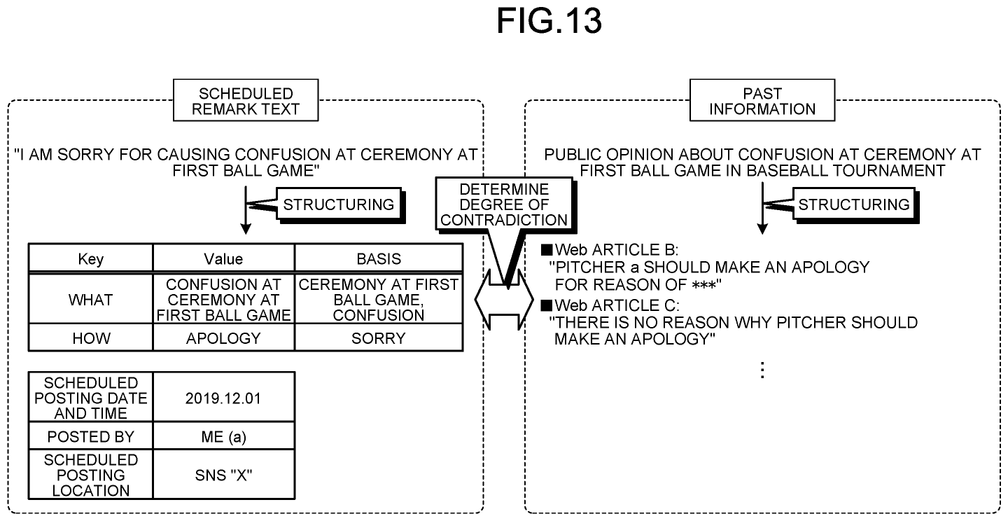

Next, a specific example #2 of information processing according to the first embodiment will be described with reference to FIGS. 10 to 12. FIG. 10 is an explanatory diagram (part 1) of the specific example #2 of information processing according to the first embodiment. Furthermore, FIG. 11 is an explanatory diagram (part 2) of the specific example #2 of information processing according to the first embodiment. Furthermore, FIG. 13 is an explanatory diagram (part 3) of the specific example #2 of information processing according to the first embodiment.

As illustrated in FIG. 10, it is assumed that the scheduled remark text of the user U is “I experienced beauty treatment at XX Tokyo Main Office with c the day before yesterday”. The input text analysis unit 13b performs structuring on the scheduled remark text as illustrated on the left side of the figure.

On the other hand, the past information analysis unit 13c performs structuring as illustrated on the right side of the figure on the past remark text, in which the account “b” other than the user U refers to the user U, “I went on a trip to Osaka with A from the day of 15”.

Then, the contradiction degree determination unit 13d compares these pieces of structured information to determine the degree of contradiction. Here, in the scheduled remark text, the user U intends to remark that he/she was in “Tokyo” on the date “2019.12.19”, but in the past information, the account “b” mentions that the user U was in “Okinawa” in a period including the date.

In such a case, since there is a contradiction in the location where the user U was on the date, the contradiction degree determination unit 13d determines that there is a contradiction. That is, the contradiction degree determination unit 13d determines that there is a contradiction when the positional ranges indicated by the positional elements included in respective analysis results of the input text analysis unit 13b and the past information analysis unit 13c do not overlap.

Then, the presentation unit 13f presents contradiction information generated by the generation unit 13e in an example as illustrated in FIG. 11 to the user U, for example. Here, this is an example in which the date on the calendar is clearly indicated and it is clearly indicated that the location where the user was on the day is contradictory between “Tokyo” and “Okinawa”.

Furthermore, as another presentation example, the presentation unit 13f presents contradiction information generated by the generation unit 13e to the user U in an example as illustrated in FIG. 12. In this example, map information is used to clearly indicate that the location on the date is contradictory between “Tokyo” and “Okinawa”. Note that, in the example illustrated in FIG. 1 in which “June” and “October” contradict each other, it can be said that the contradiction degree determination unit 13d determines that there is a contradiction when the temporal ranges indicated by the temporal elements included in respective analysis results of the input text analysis unit 13b and the past information analysis unit 13c do not overlap.

### 2-5. Specific Example #3 of Information Processing According to First Embodiment

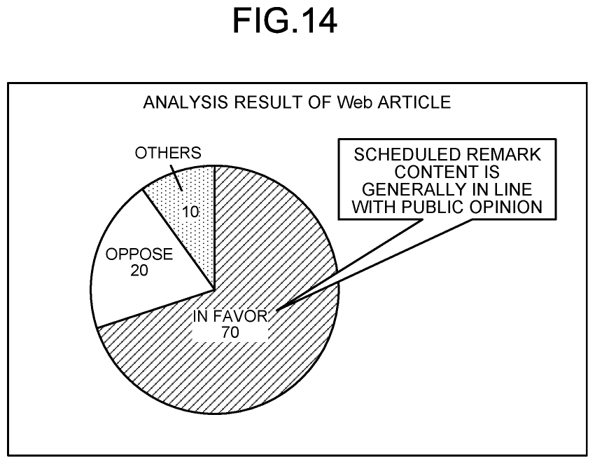

Next, a specific example #3 of information processing according to the first embodiment will be described with reference to FIGS. 13 and 14. FIG. 13 is an explanatory diagram (part 1) of the specific example #3 of information processing according to the first embodiment. Furthermore, FIG. 14 is an explanatory diagram (part 2) of the specific example #3 of information processing according to the first embodiment.

As illustrated in FIG. 12, it is assumed that the scheduled remark text of the user U is “This time, I am sorry for causing confusion at the ceremony at the first ball game”. The input text analysis unit 13b performs structuring on the scheduled remark text as illustrated on the left side of the figure.

On the other hand, the past information analysis unit 13c extracts the words of “the ceremony at the first ball game, confusion” from the result of structuring of the input text analysis unit 13b, for example, and acquires the remark text regarding “public opinion against confusion at the ceremony at the first ball game in the baseball tournament” based on the words as illustrated on the right side of the figure, and structures the remark text. At this time, the past information analysis unit 13c can use, for example, a Web article or the like as an information source.

Then, the contradiction degree determination unit 13d compares these pieces of structured information to determine the degree of contradiction. Here, the contradiction degree determination unit 13d analyzes the opinion that the remark text by the Web article or the like mentions with respect to the scheduled remark text, and determines the degree of contradiction according to how much the scheduled remark text contradicts the opinion mentioned in the Web article or the like. It can also be said that it is determined how much the scheduled remark text conforms to the opinion mentioned in the Web article or the like.

Then, the presentation unit 13f presents contradiction information generated by the generation unit 13e in an example as illustrated in FIG. 14 to the user U, for example. In this example, the contradiction information is set to “analysis result of the Web articles”, the analysis result is represented by a pie chart, and which area of the chart the scheduled remark text corresponds to is clearly indicated.

### 2-6. Specific Example #4 of Information Processing According to First Embodiment

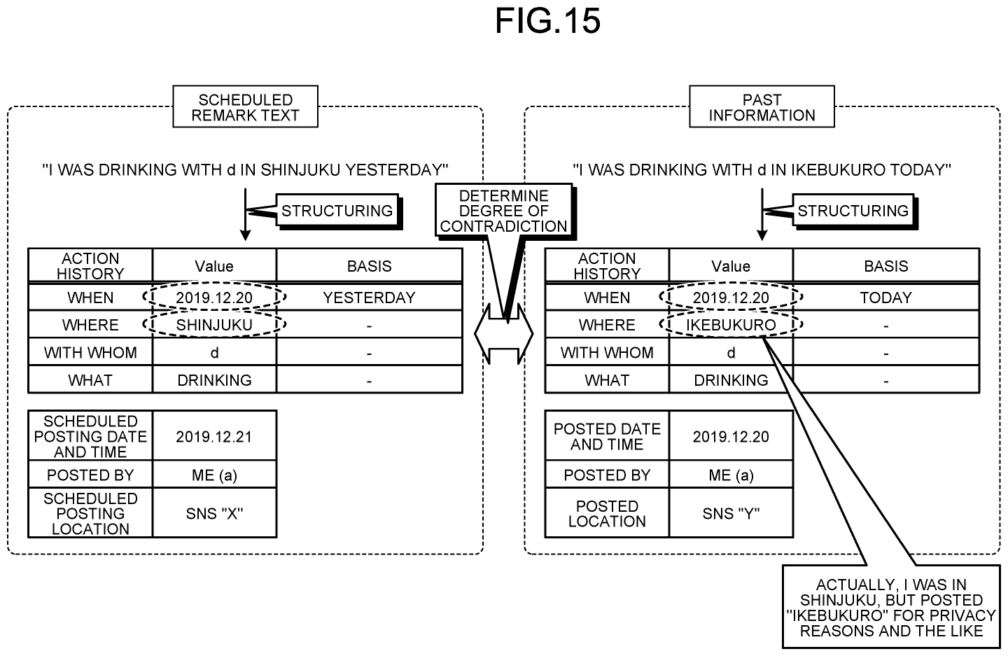

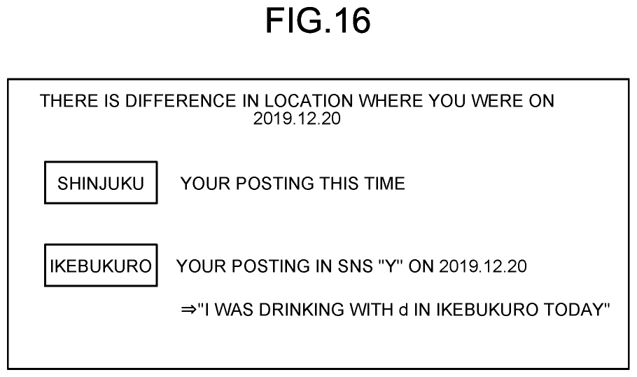

Next, a specific example #4 of information processing according to the first embodiment will be described with reference to FIGS. 15 and 16. FIG. 15 is an explanatory diagram (part 1) of the specific example #4 of information processing according to the first embodiment. Furthermore, FIG. 16 is an explanatory diagram (part 2) of the specific example #4 of the information processing according to the first embodiment.

As illustrated in FIG. 15, it is assumed that the scheduled remark text of the user U is “I was drinking with d in Shinjuku yesterday”. The input text analysis unit 13b performs structuring on the scheduled remark text as illustrated on the left side of the figure.

On the other hand, the past information analysis unit 13c performs structuring as illustrated on the right side of the figure on the past remark text “I was drinking with d in Ikebukuro today” posted on another SNS “Y” by the user U. Note that, as illustrated in the figure, the past information is assumed that the user U was actually in Shinjuku, but posted “Ikebukuro” for privacy or the like.

Then, the contradiction degree determination unit 13d compares these pieces of structured information to determine the degree of contradiction. Of course, there is a contradiction between the locations of “Shinjuku” and “Ikebukuro”, so the contradiction degree determination unit 13d determines that there is a contradiction.

Then, the presentation unit 13f presents contradiction information generated by the generation unit 13e in an example as illustrated in FIG. 16 to the user U, for example. In this example, the text clearly indicates that the location on the date is contradict between “Shinjuku” and “Ikebukuro”, and also clearly indicates the past posted remark as a basis.

### 2-7. Specific Example #5 of Information Processing According to First Embodiment

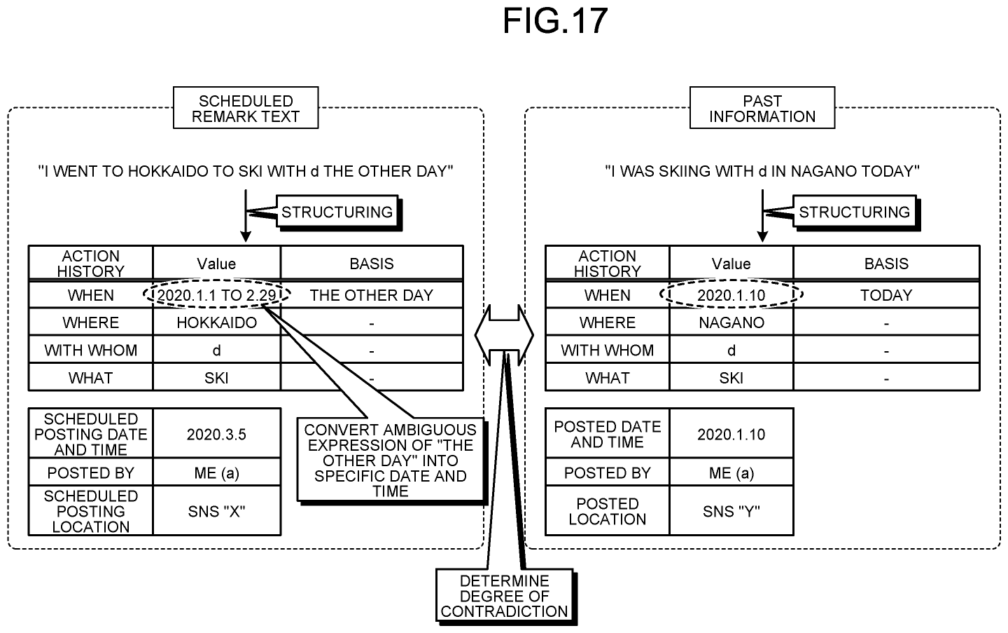

Next, a specific example #5 of information processing according to the first embodiment will be described with reference to FIG. 17. FIG. 17 is an explanatory diagram of the specific example #5 of information processing according to the first embodiment.

As illustrated in FIG. 17, it is assumed that the scheduled remark text of the user U is “I went skiing with d in Hokkaido the other day”. The input text analysis unit 13b performs structuring on the scheduled remark text as illustrated on the left side of the figure.

Note that, at this time, as illustrated in the figure, in a case where there is an ambiguous expression of “the other day”, the input text analysis unit 13b performs an estimation from, for example, “scheduled posting date and time” and converts the “the other day” into a specific date and time. As described above, when an ambiguous expression is included in the text, the input text analysis unit 13b performs analysis to specify the ambiguous expression as much as possible.

Then, the past information analysis unit 13c performs structuring as illustrated on the right side of the figure on the past remark text “I was skiing with d in Nagano today” corresponding to the specified date and time.

Then, the contradiction degree determination unit 13d compares these pieces of structured information to determine the degree of contradiction. In the case of the example of the figure, since there is an overlap in the date and time and the companion, the contradiction degree determination unit 13d determines that the behavior information is the same. In addition, since the location is contradictory between “Hokkaido” and “Nagano”, the contradiction degree determination unit 13d determines that there is a contradiction and presents “Nagano” as a correction draft.

When there is no overlap in date and time such as “I went skiing with d in Hokkaido last year” in the scheduled remark text, the contradiction degree determination unit 13d determines that there is no contradiction since it determines that the information is not the same behavior information, and does not present the correction draft.

### 2-8. Specific Example #6 of Information Processing According to First Embodiment

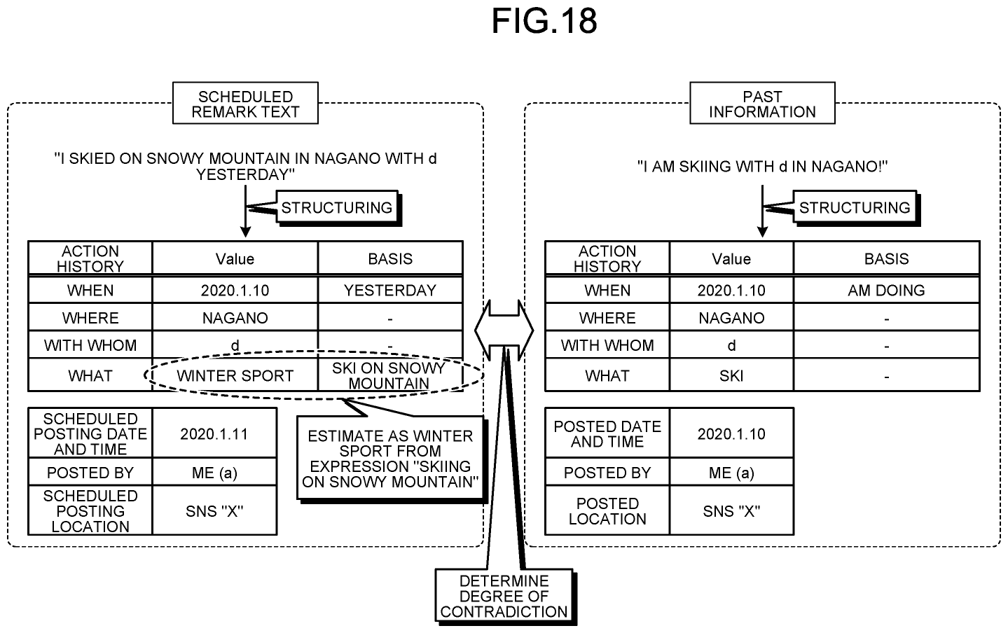

Next, a specific example #6 of information processing according to the first embodiment will be described with reference to FIG. 18. FIG. 18 is an explanatory diagram of the specific example #6 of information processing according to the first embodiment.

As illustrated in FIG. 18, it is assumed that the scheduled remark text of the user U is “I slid on a snowy mountain in Nagano with d yesterday.”. The input text analysis unit 13b performs structuring on the scheduled remark text as illustrated on the left side of the figure.

At this time, as illustrated in the figure, when there is an ambiguous expression of “sliding on a snowy mountain”, the input text analysis unit 13b estimates from the meaning of “sliding on a snowy mountain” and analyzes the text as at least “winter sport”. As described above, when an ambiguous expression is included in the text, the input text analysis unit 13b performs analysis to specify the ambiguous expression as much as possible.

Then, the past information analysis unit 13c performs structuring on the past remark text “We are skiing in Nagano with d!” corresponding to the specified “winter sport” as illustrated on the right side of the figure.

Then, the contradiction degree determination unit 13d compares these pieces of structured information to determine the degree of contradiction. In a case where only the text of the surface “sliding on a snowy mountain” described above is viewed, it seems that it is not related to the text of we are skiing”, but when it is possible to analyze the text as “playing winter sport”, since “skiing” is included in “winter sport”, it is possible to determine that it is the same behavior information and to determine the degree of contradiction. In such a case, the contradiction degree determination unit 13d determines that there is no contradiction in a case where the behavioral elements included in respective analysis results of the input text analysis unit 13b and the past information analysis unit 13c are different from each other, but one behavioral element (here, “skiing”) is included in the other behavioral element (here, “winter sport”).

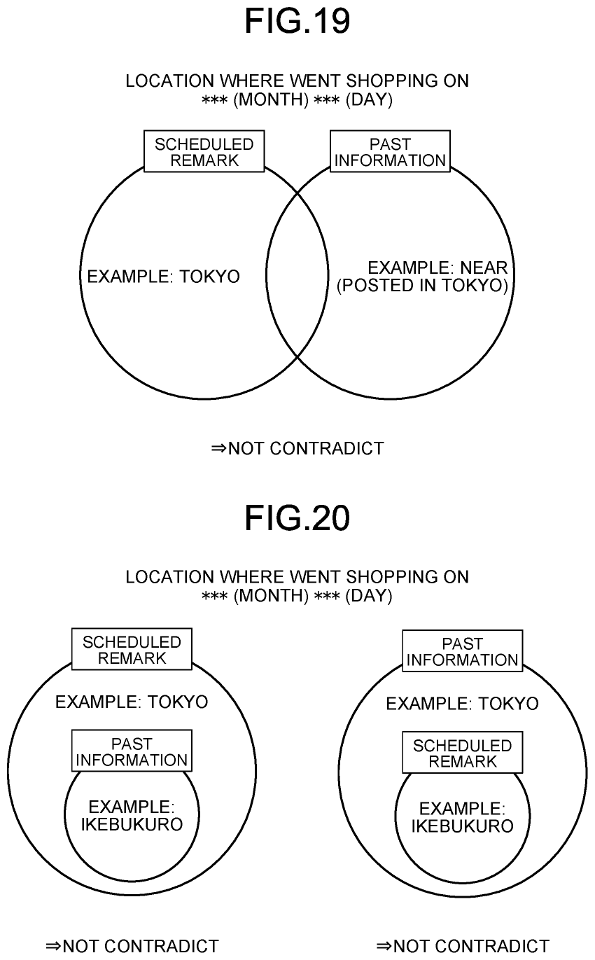

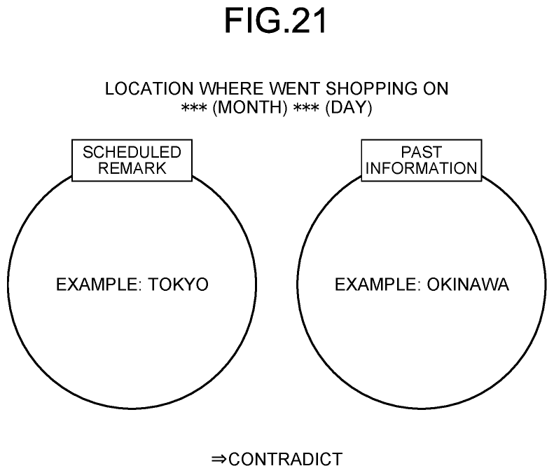

Here, some patterns of the contradiction degree determination result by the contradiction degree determination unit 13d will be described. FIG. 19 is a diagram (part 1) illustrating a pattern of the contradiction degree determination result. FIG. 20 is a diagram (part 2) illustrating a pattern of the contradiction degree determination result. FIG. 21 is a diagram (part 3) illustrating a pattern of the contradiction degree determination result.

The contradiction degree determination unit 13d determines the degree of contradiction after the unique expression indicating the date and time, the location, the name of the event in which the user U participated, the amount of money, and the like, the abstract expression indicating the behavior of the user U, and the like are specified to a level that can be determined by the analysis process by the input text analysis unit 13b and the past information analysis unit 13c.

In addition, for example, as illustrated in FIG. 19, for “a location where I went shopping on *** (month) *** (day)”, in a case where the scheduled remark text represents “Tokyo” and the past information represents “near” Tokyo, the locations intersect with each other, and thus the contradiction degree determination unit 13d determines that there is no contradiction.

Furthermore, for example, as illustrated in FIG. 20, for “a location where I went shopping on *** (month) *** (day)”, in a case where one of the scheduled remark text and the past information represents “Tokyo” and the other represents “Ikebukuro”, any one of the locations is included in the other location, and thus, the contradiction degree determination unit 13d determines that there is no contradiction.

Furthermore, for example, as illustrated in FIG. 21, for “a location where I went shopping on *** (month) *** (day)”, in a case where the scheduled remark text represents “Tokyo” and the past information represents “in Okinawa”, the locations do not intersect, and thus the contradiction degree determination unit 13d determines that there is a contradiction.

### 2-9. Specific Example #7 of Information Processing According to First Embodiment

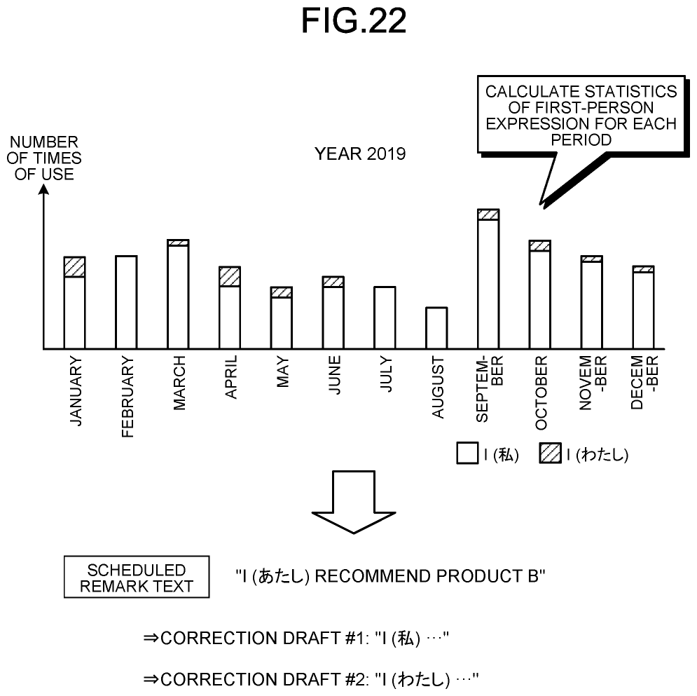

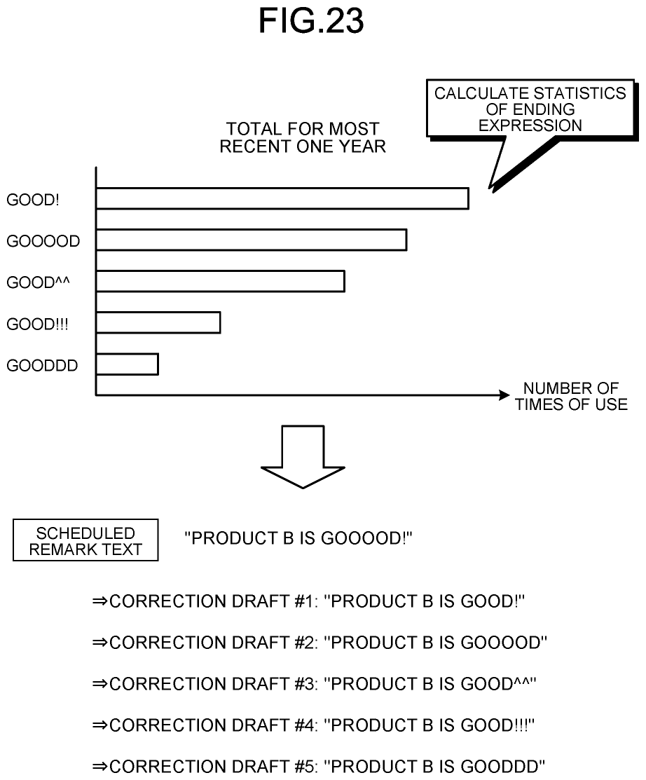

Next, a specific example #7 of information processing according to the first embodiment will be described with reference to FIGS. 22 and 23. FIG. 22 is an explanatory diagram (part 1) of the specific example #7 of information processing according to the first embodiment. Furthermore, FIG. 23 is an explanatory diagram (part 2) of the specific example #7 of the information processing according to the first embodiment.

In the description using FIGS. 22 and 23, a feature extraction process executed by the feature extraction unit 13cb of the past information analysis unit 13c and a use example of a processing result thereof will be described.

As described above, the feature extraction unit 13cb extracts the feature of the user U based on the past remark text of the user U himself/herself acquired by the acquisition unit 13a, and registers the feature in the feature information 12c. Specifically, as illustrated in FIG. 22, the feature extraction unit 13cb calculates statistics for each period of the first-person expression of the past remark text of the user U, for example.

Then, based on the calculation result, the generation unit 13e generates the correction draft so that the remark looks like one by the user U. For example, in FIG. 22, as a result of calculation of statistics by the feature extraction unit 13cb, the feature is extracted in which many of the first-person expression of the user U is “I( [symbol] )” in many cases and is “I( [symbol] )” in the rest cases.

Then, in response to this, for example, in a case where the scheduled remark text represents “I( [symbol] ) recommend product B”, the generation unit 13e generates, as a correction draft #1, a correction draft in which the first-person expression is changed to “I( [symbol] ) . . . ”. Next, the generation unit 13e generates, as a correction draft #2, a correction draft in which the first-person expression is changed to “I( [symbol] ) . . . ”. Then, the generation unit 13e causes the presentation unit 13f to present the generated correction draft to the user U.

Note that, as illustrated in FIG. 23, the feature extraction unit 13cb calculates, for example, statistics of ending expressions of the user in the past remark text of the user U in addition to the first-person expression. FIG. 23 illustrates an example in which the feature extraction unit 13cb calculates the total number of times of use for each ending expression in the last 1 year.

Then, in accordance with the calculation result, for example, in a case where the scheduled remark text represents “Product B is goood!”, the generation unit 13e sequentially generates the correction drafts #1, #2, . . . in which the ending expressions are changed in the descending order of the total number of times of use, and causes the presentation unit 13f to present the correction drafts to the user U.

As a result, it is possible to present the user U with a correction draft that provides an expression more fitting to the user U.

### 2-10. Specific Example #8 of Information Processing According to First Embodiment

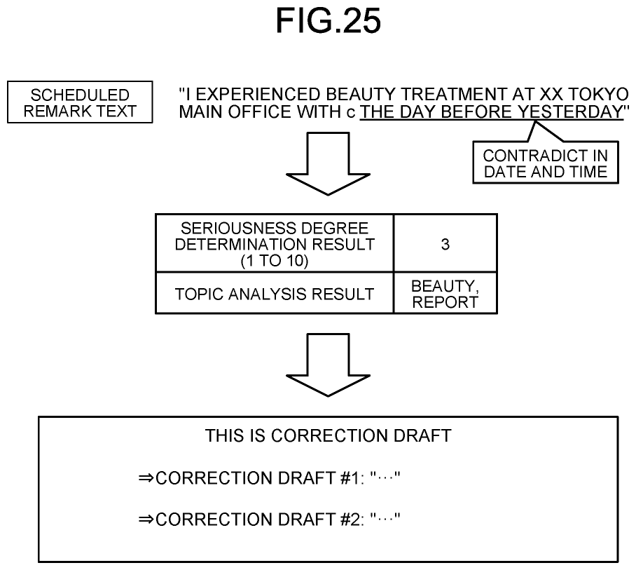

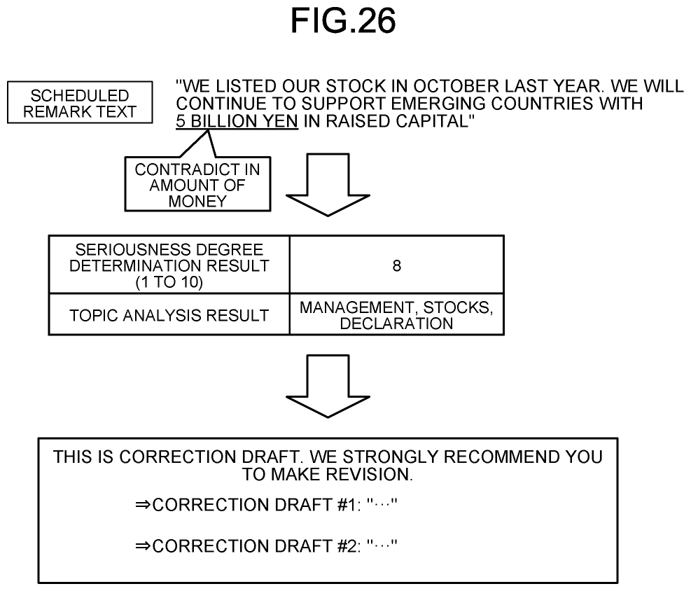

Next, a specific example #8 of information processing according to the first embodiment will be described with reference to FIGS. 24 to 26. FIG. 24 is an explanatory diagram (part 1) of the specific example #8 of information processing according to the first embodiment. Furthermore, FIG. 25 is an explanatory diagram (part 2) of the specific example #8 of the information processing according to the first embodiment. Furthermore, FIG. 26 is an explanatory diagram (part 3) of the specific example #8 of the information processing according to the first embodiment.

In the description using FIGS. 24 to 26, a situation determination process executed by the situation determination unit 13bb of the input text analysis unit 13b and a use example of a processing result thereof will be described.

As described above, the situation determination unit 13bb determines the degree of seriousness of the scheduled remark text of the user U using the situation determination model 12d. In addition, as described above, the situation determination model 12d is a determination model for determining the situation, particularly the degree of seriousness, indicated by the scheduled remark text of the user U.

Specifically, as illustrated in FIG. 24, the situation determination model 12d is generated by learning using a neural network or the like based on the degree of seriousness for each topic set in advance. Note that, as illustrated in the figure, in a case where the degree of seriousness is manually corrected, a topic is added, or the like, relearning is appropriately performed.

Then, as illustrated in the figure, the situation determination unit 13bb determines the degree of seriousness of the scheduled remark text by, for example, a hybrid method using the situation determination model 12d and the special rule.

For example, the situation determination unit 13bb inputs the scheduled remark text “Our party will lead the political measures to reduce plastic waste” to the situation determination model 12d generated/updated based on the degree of seriousness for each topic as illustrated in the figure, and obtains an output value thereof. Then, the situation determination unit 13bb obtains a final determination result by applying the special rule to the output value.

In the example of the figure, it can be seen that the seriousness degree determination result of the scheduled remark text is “high”, the topic analysis result is “environment, politics”, and the special rule application is “yes”.

Using such a determination result, the presentation unit 13f can urge correction with a remark corresponding to the determination result. For example, as illustrated in FIG. 25, it is assumed that, although there is a contradiction in date and time in the scheduled remark text, the result in which the degree of seriousness is “3” in 10 stages of 1 to 10, which is a not-so high, is obtained.

Then, as illustrated in the figure, the presentation unit 13f prompts the user U to make a correction, so to speak, in a normal tone that is not so strong, such as “Here is the correction draft”.

On the other hand, for example, as illustrated in FIG. 26, it is assumed that there is a contradiction in the amount of money in the scheduled remark text, and the result in which the degree of seriousness is “8” in 10 stages of 1 to 10, which is high, of is obtained.

Then, as illustrated in the figure, the presentation unit 13f urges the user U to make a correction in a strong tone, such as “This is a correction draft. We strongly recommend the correction.”. That is, under a sensitive situation in which there is a high possibility that an inappropriate remark causes so-called burning, the presentation unit 13f strongly recommends the user U to make a correction in order to prevent burning. As a result, it is possible to assist the user U to remark more safely in an opportunity to remark in a public place.

### 2-11. Processing Procedure of Information Processing According to First Embodiment

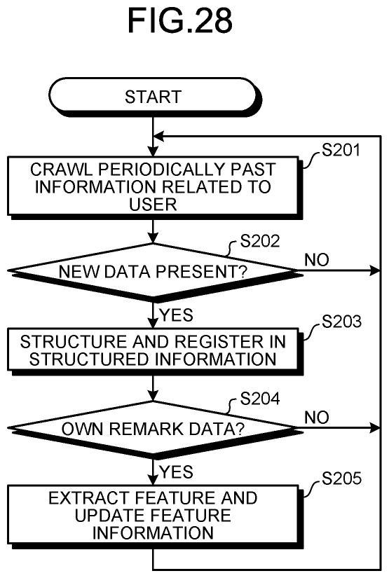

Next, a processing procedure executed by the server device 10 according to the first embodiment will be described with reference to FIGS. 27 and 28. FIG. 27 is a flowchart (part 1) illustrating a processing procedure executed by the server device 10 according to the first embodiment. FIG. 28 is a flowchart (part 2) illustrating a processing procedure executed by the server device 10 according to the first embodiment.

Note that FIG. 27 illustrates a processing procedure executed each time the scheduled remark text is input, and FIG. 28 illustrates a processing procedure constantly executed.

As illustrated in FIG. 27, when the text input by the user U starts, it is determined whether the input has been completed (step S101). When the input is not completed (step S101, No), step S101 is repeated. When the input is completed (step S101, Yes), the contradiction degree determination unit 13d determines, through input text analysis processing (not illustrated), the degree of contradiction with the past information (step S102).

Then, it is determined whether there is a contradiction as a result of the determination (step S103). In a case where there is a contradiction (step S103, Yes), the presentation unit 13f presents contradiction information to the user U (step S104). Furthermore, the presentation unit 13f presents the correction draft to the user U (step S105).

Then, it is determined whether there is a correction input by the user U for such a correction draft (step S106). Here, in a case where there is a correction input (step S106, Yes), the process from step S101 is repeated.

Furthermore, in a case where there is no correction input (step S106, No), or in a case where there is no contradiction in step S103 (step S103, No), the presentation unit 13f causes the user U to confirm the posted content (step S107).

Then, it is determined whether the user U has approved the post (step S108). When the user U approves the post (step S108, Yes), it is determined whether an approval request destination is set (step S109). Here, in a case where the approval request destination is set (step S109, Yes), the posted content is transmitted to the approval request destination (step S110), and approval is requested. Then, it is determined whether the post is approved by an approver X of the request destination (step S111).

When the post is approved by the approver X (step S111, Yes), an approval notification from the approver X is received (step S112), and the post is received with the approved content (step S113). Then, various types of related information (for example, various types of stored information stored in the storage unit 12) are updated (step S114), and the process ends. Furthermore, in a case where the post is not approved by the approver X (step S111, No), a disapproval notification from the approver X is received (step S115), and the process from step S101 is repeated. Furthermore, also in a case where the user U himself/herself does not approve the post (step S108, No), the process from step S101 is repeated.

Next, in the constantly executed processing, as illustrated in FIG. 28, the acquisition unit 13a periodically crawls the past information related to the user U (step S201). Then, it is determined whether there is new data (step S202).

Here, when there is new data (step S202, Yes), the second structuring processing unit 13ca of the past information analysis unit 13c structures the data and registers the data in the structured information 12b (step S203).

Then, it is determined whether the data is the user U's own remark data (step S204). Here, in a case where it is the user U's own remark data (step S204, Yes), the feature extraction unit 13cb of the past information analysis unit 13c extracts the feature of the user U and updates the feature information 12c (step S205). Then, the process from step S201 is repeated.

Furthermore, in a case where there is no new data (step S202, No), or in a case where the data is not the user U's own remark data (step S204, No), the process from step S201 is repeated.

### 2-12. Display Screen Example of Information Processing According to First Embodiment

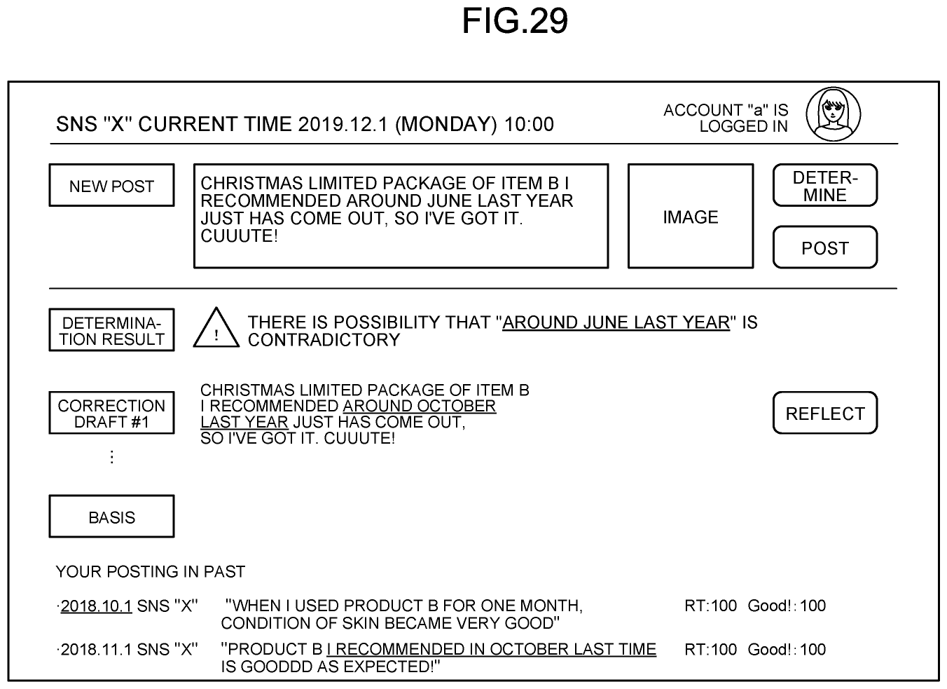

Next, a display screen example of information processing according to the first embodiment will be described with reference to FIG. 29. FIG. 29 is a diagram illustrating a display screen example of information processing according to the first embodiment.

First, the user U inputs the scheduled remark text to the new post field on the display screen illustrated in FIG. 29. Then, the user U operates the “DETERMINE” button. Then, the scheduled remark text is acquired by the server device 10, and the server device 10 executes the contradiction degree determination process to present “DETERMINATION RESULT”, “CORRECTION DRAFT #1” . . . , and “BASIS” on the display screen.

A “REFLECT” button is associated with each correction draft, and when the user U operates the “REFLECT” button, the correction draft is automatically reflected in the scheduled remark text in the new post field.

Then, when the user U operates the “POST” button, the scheduled remark text in the new post field is posted together with the attached image.

<<3. Modification of First Embodiment>>

<3-1. First modification>

So far, the example in which the case where the user U inputs the scheduled remark text in the new post field is set as a trigger is described, but the first embodiment can also be applied to a case where the user U replies to a post from an account other than the user U. Next, such an example will be described as a first modification.

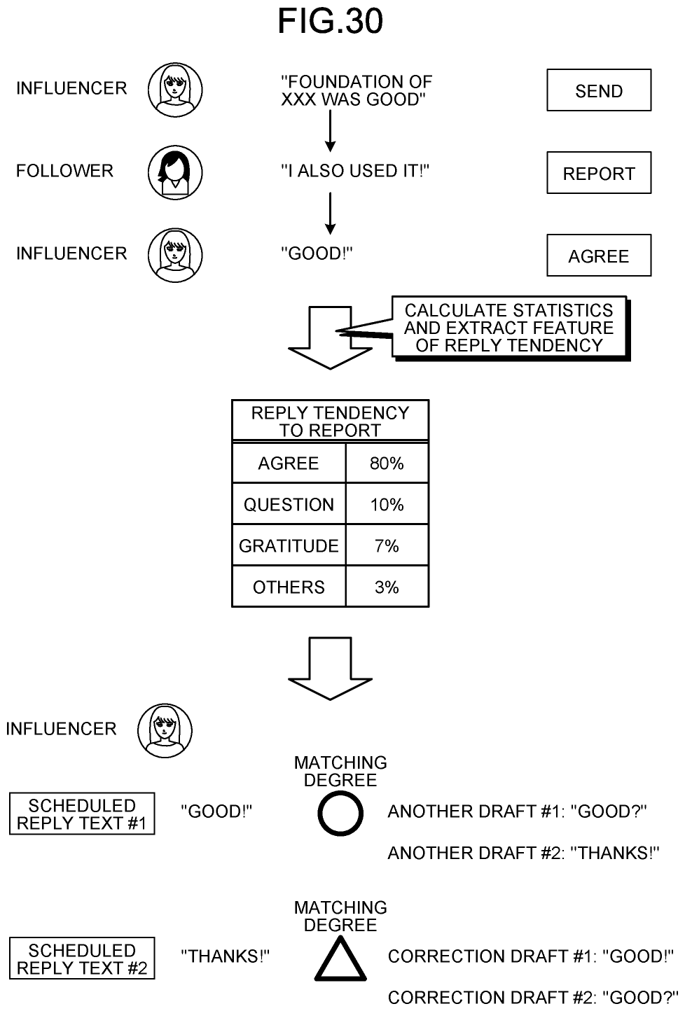

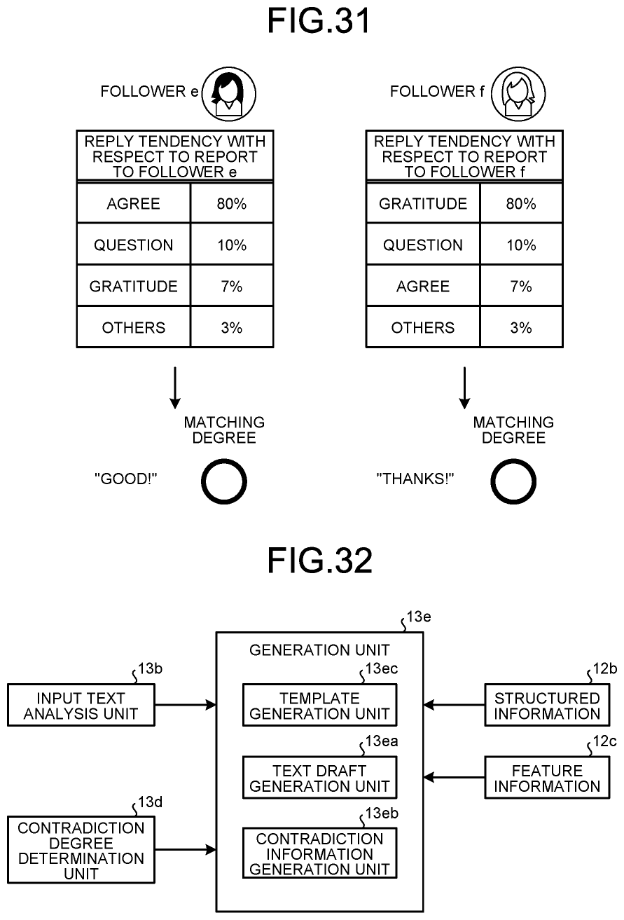

FIG. 30 is an explanatory diagram (part 1) of the first modification. FIG. 31 is an explanatory diagram (part 2) of the first modification.

As illustrated in FIG. 30, it is assumed that the user U is an influencer, and a case where “SEND” is first performed, followed by “REPORT” of the follower, and the user U further replies to “REPORT” with “AGREE” will be considered.

In such a case, in the first modification, as illustrated in the figure, the feature extraction unit 13cb calculates statistics and extracts the feature of a reply tendency by the user U. Here, it is assumed that the feature extraction unit 13cb extracts a reply tendency by the user U to “REPORT” of the follower as illustrated in the center of the figure.

Then, in the first modification, in a case where the user U inputs the scheduled reply text, the matching degree with the reply tendency and the correction draft according thereto are presented.

Specifically, for “Good!” of the scheduled reply text #1 indicating “AGREE”, “AGREE” accounts for as much as “80%” in the reply tendency of the user U. Therefore, the presentation unit 13f presents, for example, a mark “GOOD” indicating the text has a high matching degree. Furthermore, since the matching degree is high, a reply text indicating “QUESTION” or “GRATITUDE” is presented as another draft instead of the correction draft.

Furthermore, for “Thanks!” of the scheduled reply text #2 indicating “GRATITUDE”, the proportion of “GRATITUDE” is as low as “7%” in the reply tendency of the user U. Therefore, the presentation unit 13f determines that the matching degree is low, and presents a mark “FAIR”, for example. In addition, since the matching degree is low, for example, a reply text indicating a correction draft with a high matching degree, that is, “AGREE” or “QUESTION” is presented.

As a result, it is possible to assist the user U to return a reply that has a high matching degree with the past reply tendency of the user U, that is, a reply that is fit to the usual user U.

Furthermore, in the first modification, as illustrated in FIG. 31, a reply tendency to followers may be extracted for each follower. Then, depending on the reply tendency for each follower, an assist may be provided so that a reply with a high matching degree can be returned.

<3-2. Second Modification>

Next, the second modification will be described with reference to FIGS. 32 and 33. The second modification is an example in which, in a case where the user U replies to an account other than the user U, a candidate for the scheduled reply text is automatically generated according to the text to which a reply is to be made which is a text sent from the account other than the user U.

FIG. 32 is a block diagram illustrating a configuration example of the generation unit 13e according to the second modification. Note that FIG. 32 corresponds to FIG. 7. Therefore, here, points different from FIG. 7 will be mainly described. As illustrated in FIG. 32, the generation unit 13e according to the second modification further includes a template generation unit 13ec. The template generation unit 13ec generates a reply template according to the structure based on the structure of the text to which a reply is to be made analyzed by the input text analysis unit 13b.

For example, in a case where the text to which a reply is to be made asks “When did you go here?”, the reply template is generated including a format for replying date and time. Furthermore, for example, in a case where the text to which a reply is to be made requires empathy, the reply template is generated including a format in which an intention of empathy can be expressed.

Then, the text draft generation unit 13ea generates candidates for the scheduled reply text based on the reply template generated by the template generation unit 13ec, the reply tendency by the user U with respect to the account to which a reply is to be made included in the feature information 12c, and the like. The user U selects one of the candidates, makes a correction as necessary, and replies to the account to which a reply is to be made.

As a result, it is possible to reply to the text to which a reply is to be made very easily and in a sentence like the user U.

Next, a processing procedure executed by the server device 10 according to the second modification will be described with reference to FIG. 33. FIG. 33 is a flowchart illustrating a processing procedure executed by the server device 10 according to the second modification.

As illustrated in FIG. 33, in the second modification, first, the acquisition unit 13a acquires the text to which a reply is to be made (step S301). Then, the template generation unit 13ec generates a reply template based on the structured structure of the text (step S302).

Then, the text draft generation unit 13ea generates candidates for the scheduled reply text based on the feature of the reply tendency of the user U while using the reply template (step S303). Then, the presentation unit 13f presents the candidates to the user U (step S304).

Then, it is determined whether any of the candidates is approved by the user U (step S305). When it is approved (step S305, Yes), it is determined whether an approval request destination is set (step S308). Here, in a case where the approval request destination is set (step S308, Yes), the posted content is transmitted to the approval request destination (step S309), and the approval is requested. Then, it is determined whether the post is approved by the approver X of the request destination (step S310).

When the post is approved by the approver X (step S310, Yes), an approval notification from the approver X is received (step S311), the post is made with the approved content (step S312), and then the process is terminated. Furthermore, in a case where the post is not approved by the approver X (step S310, No), a disapproval notification from the approver X is received (step S313), and the process from step S305 is repeated. Furthermore, in a case where the post is not approved in step S305 (step S305, No), the user U is requested to make a correction (step S306). Then, it is determined whether the correction is completed (step S307).

When the correction is completed (step S307, Yes), the process from step S305 is repeated. On the other hand, if the correction is not completed (step S307, No), the process from step S306 is repeated.

<<4. Summary of First Embodiment>>

As described above, according to the first embodiment of the present disclosure, the server device 10 (corresponding to an example of the “information processing apparatus”) includes the acquisition unit 13a that acquires the text related to the remark of the user U who has refrained from sending the remark, the input text analysis unit 13b (corresponding to an example of the “first analysis unit”) that analyzes, by a natural language process, the text related to the remark acquired by the acquisition unit 13a, the past information analysis unit 13c (corresponding to an example of the “second analysis unit”) that analyzes past information related to the content of the remark by the natural language process, and the generation unit 13e that generates a candidate for the remark text sent by the user U so that there is no contradiction with the past information based on the comparison between the respective analysis results of the input text analysis unit 13b and the past information analysis unit 13c. As a result, it is possible to assist the user U to remark more safely in an opportunity to remark in a public place.

### Second Embodiment

<<5. Overview of Information Processing Method According to Second Embodiment>>

Next, the second embodiment will be described. In the information processing method according to the second embodiment of the present disclosure, one or more competitors are set with respect to the user U, and in a case where an opinion by the competitor has already been made with respect to the content of the scheduled remark text of the user U, a correction draft of the scheduled remark text for each case of conforming/not conforming the opinion is presented.

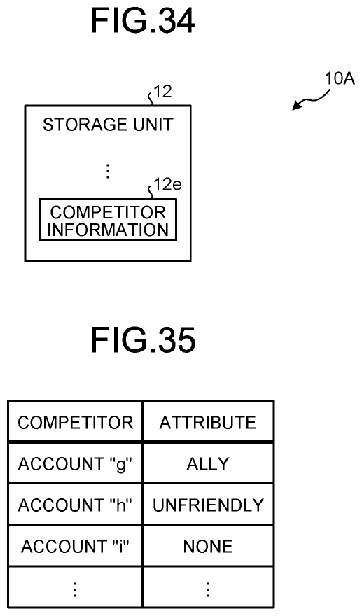

A specific description will be given below with reference to FIGS. 34 to 39. Hereinafter, the description of the same configuration as that of the first embodiment will be omitted, and portions mainly different from those of the first embodiment will be described. Furthermore, for convenience, the information processing system according to the second embodiment is denoted by reference numeral “1A”, and the server device is denoted by reference numeral “10A”.

<<6. Configuration of Information Processing System According to Second Embodiment>>

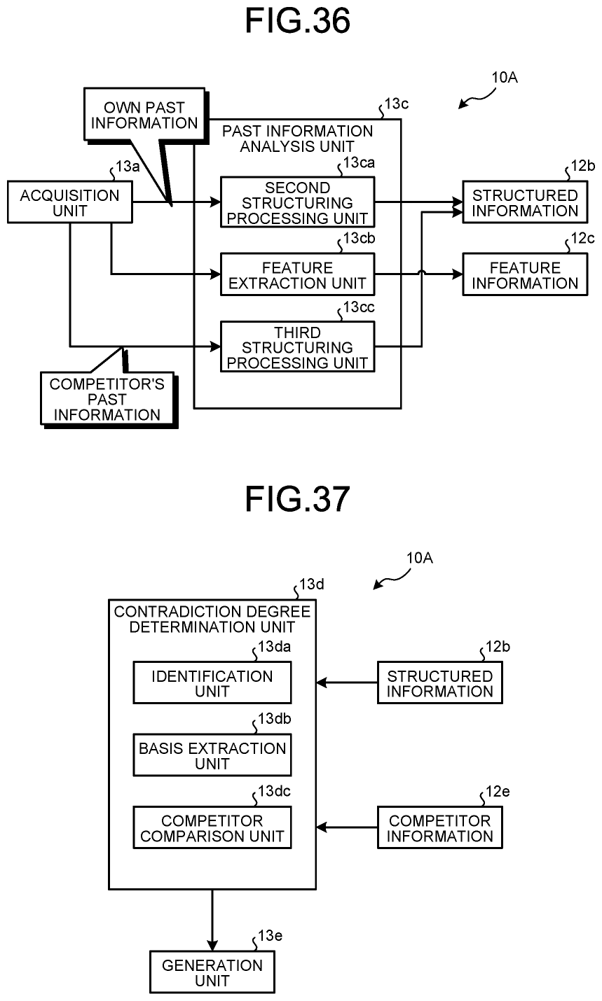

FIG. 34 is a block diagram illustrating a configuration example of the storage unit 12 of a server device 10A according to the second embodiment. Furthermore, FIG. 35 is a diagram illustrating an example of competitor information 12e. FIG. 36 is a block diagram illustrating a configuration example of the past information analysis unit 13c of the server device 10A according to the second embodiment.

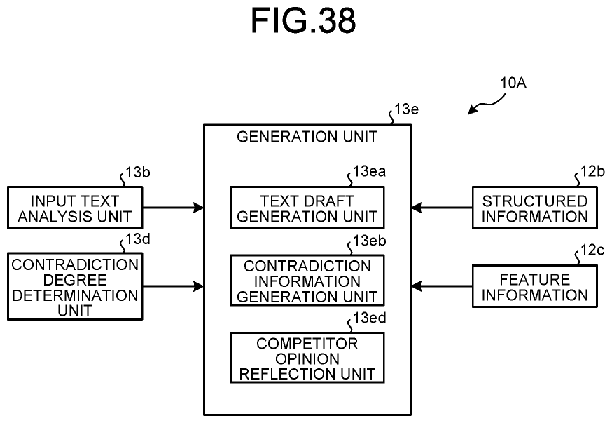

FIG. 37 is a block diagram illustrating a configuration example of the contradiction degree determination unit 13d of the server device 10A according to the second embodiment. FIG. 38 is a block diagram illustrating a configuration example of the generation unit 13e of the server device 10A according to the second embodiment.

As illustrated in FIG. 34, the storage unit 12 of the server device 10A further stores the competitor information 12e. The competitor information 12e is information about a competitor of the user U.

Specifically, as illustrated in FIG. 35, one or more accounts or persons may be registered in the competitor information 12e as “competitors” of the user U. Here, an example is illustrated in which at least accounts “g”, “h”, and “i” are registered.

Furthermore, as illustrated in the figure, “ATTRIBUTE” is set for each of the competitors. In “ATTRIBUTE”, an attribute value indicating a relationship with the user U is set. For example, “ALLY” is an attribute value indicating that the competitor is in an ally relationship with the user U. Furthermore, “UNFRIENDLY” is an attribute value indicating that the competitor is in an unfriendly relationship with the user U. Furthermore, “NONE” can be set to “NONE” in the case where an account or a person is not in an ally or unfriendly relationship but the user U wants to watch it, for example. “ALLY” may also be referred to as “FRIENDLY”

Then, the acquisition unit 13a of the server device 10A periodically crawls the action such as posting of each of the competitors registered in the competitor information 12e. Furthermore, in a case where the scheduled remark text of the user U is input, when there is a competitor's post or the like prior to that of the user U regarding the content thereof, the acquisition unit 13a acquires the remark text of the competitor. The past information analysis unit 13c of the server device 10A analyzes the remark text of the competitor.

As illustrated in FIG. 36, the past information analysis unit 13c of the server device 10A further includes a third structuring processing unit 13cc. The third structuring processing unit 13cc performs the natural language process on the past remark text of the competitor acquired by the acquisition unit 13a by an algorithm such as NLU to structure the text. In addition, the third structuring processing unit 13cc registers the structured information in the structured information 12b.

That is, as illustrated in the figure, while the second structuring processing unit 13ca structures the past remark text of the user U himself/herself or the past remark text in which anyone/anything other than the user U refers to the user U, that is, the past information about the user U himself/herself, the third structuring processing unit 13cc structures the past information about the competitor.

Then, the contradiction degree determination unit 13d of the server device 10A compares the structured past information about the competitor with the structured scheduled remark text of the user U, and determines the degree of contradiction in a so-called broad sense such as whether the competitor and the user U have the same opinion or an opposite opinion.

As illustrated in FIG. 37, the contradiction degree determination unit 13d of the server device 10A further includes a competitor comparison unit 13dc. The competitor comparison unit 13dc compares past information of the competitor with the scheduled remark text of the user U based on the structured information 12b and the competitor information 12e, and analyzes whether the competitor and the user U have the same opinion, an opposite opinion, and a degree of the difference, whether the determination is possible, or the like. In addition, the competitor comparison unit 13dc outputs the analysis result to the generation unit 13e.

Then, as illustrated in FIG. 38, the generation unit 13e of the server device 10A further includes a competitor opinion reflection unit 13ed. The competitor opinion reflection unit 13ed reflects the competitor's opinion on the presentation content to the user U based on the analysis result by the competitor comparison unit 13dc.

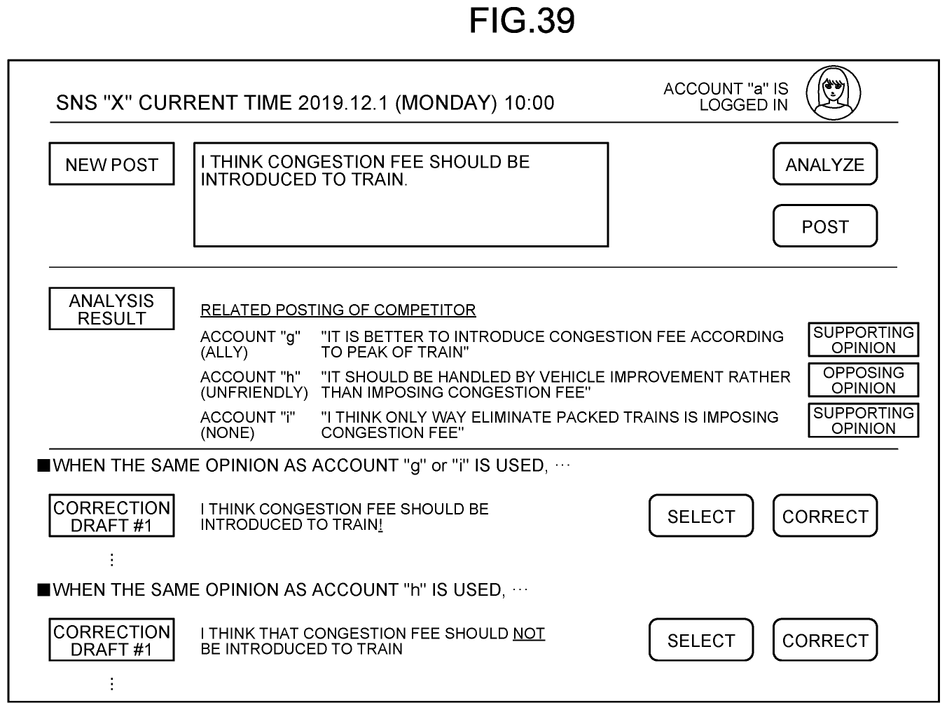

Next, a display screen example of the information processing according to the second embodiment reflecting the opinion of the competitor will be described with reference to FIG. 39. FIG. 39 is a diagram illustrating a display screen example of information processing according to the second embodiment.

First, the user U inputs the scheduled remark text to the new post field on the display screen illustrated in FIG. 39. Here, it is assumed that “I think a congestion fee should be introduced to the train”. Then, the user U operates the “ANALYZE” button.

Then, the scheduled remark text is acquired by the server device 10A, and the server device 10A executes the contradiction degree determination process including the competitor comparison process and presents “ANALYSIS RESULT” and respective correction drafts on the display screen.

Here, in “ANALYSIS RESULT”, related posts of the competitors are displayed in a list together with, for example, the competitors and its attributes. Furthermore, for example, in each line of the list, whether it is “SUPPORTING OPINION” or “OPPOSING OPINION” with respect to the scheduled remark text of the user U is clearly indicated.

Then, the correction drafts are presented, for example, for each case of conforming/not conforming respective competitors. In the example of FIG. 39, with respect to the scheduled remark text of the user U, the correction draft in a case of conforming those of the accounts “g” and “i” with “SUPPORTING OPINION” and the correction draft in a case of conforming that of the account “h” with “OPPOSING OPINION” are presented.

Therefore, with “ally/unfriendly/none” as the attribute of the competitor, the user U can select a correction draft having the same opinion as that of the competitor when the user U confirms the related post of the competitor and is satisfied with, for example, the opinion of the competitor who is usually “unfriendly”.

The “SELECT” button is associated with each correction draft, and when the user U operates the “SELECT” button, the corresponding correction draft is automatically reflected in the scheduled remark text in the new post field. In addition, the “CORRECT” button is associated with each correction draft, and when the user U operates the “CORRECT” button, the corresponding correction draft can be appropriately corrected.

Then, when the user U operates the “POST” button, the scheduled remark text in the new post field is posted.

<<7. Summary of Second Embodiment>>

As described above, according to the second embodiment of the present disclosure, the past information analysis unit 13c of the server device 10A (corresponding to an example of the “information processing apparatus”) analyzes the past information in a case where a competitor (corresponding to an example of “another user”) having at least an effective attribute or an unfriendly attribute is set with respect to the user U and the past information about the opinion of the competitor regarding the content of the remark exists, and the generation unit 13e generates a candidate for the remark text for each of a case of conforming to and a case of not conforming to the opinion of the competitor based on the analysis result by the past information analysis unit 13c. As a result, it is possible to assist the user U to remark more safely while considering the opinions of the competitors in an opportunity to remark in a public place.

### Third Embodiment

<<8. Outline of Third Embodiment>>

Next, the third embodiment will be described. The information processing method according to the third embodiment of the present disclosure includes assuming a scene such as a press conference or an interview, performing speech recognition on a question to the user U who is a responder, converting the question into a text to analyzing it, acquiring and analyzing past information according to the content of the text, generating a candidate for a response sentence to the question so that there is no contradiction with the past information, and presenting the candidate to the user U.

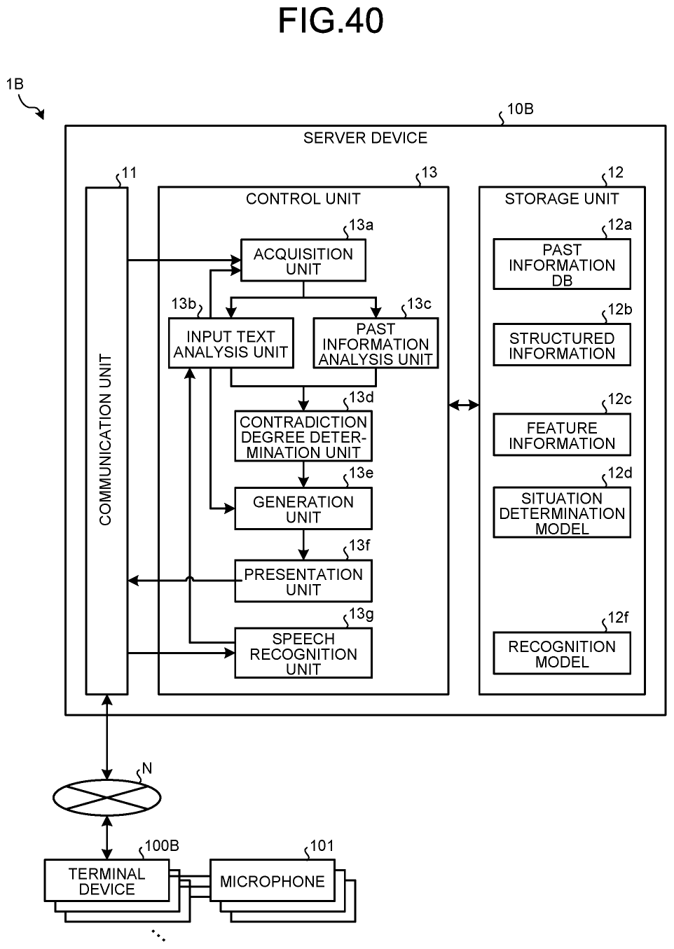

A specific description will be given below with reference to FIGS. 40 to 45. Hereinafter, the description of the same configuration as that of the first embodiment will be omitted, and portions mainly different from those of the first embodiment will be described. Furthermore, for convenience, the information processing system according to the third embodiment is denoted by reference numeral “1B”, the server device is denoted by reference numeral “10B”, and the terminal device is denoted by reference numeral “100B”.

<<9. Configuration of Information Processing System According to Third Embodiment>>

### 9-1. Configuration of Server Device and Other Devices

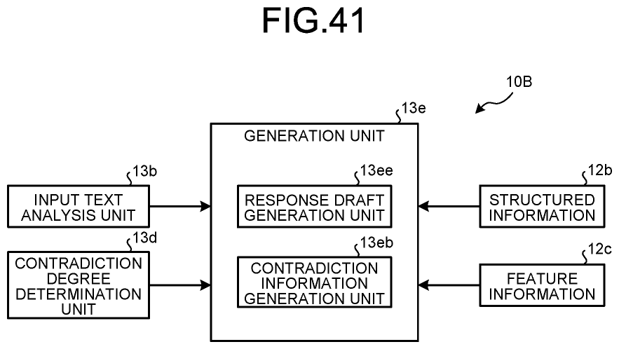

FIG. 40 is a block diagram illustrating a configuration example of a server device 10B according to the third embodiment. In addition, FIG. 41 is a block diagram illustrating a configuration example of the generation unit 13e of a server device 10B according to the third embodiment.

As illustrated in FIG. 40, a server device 10B according to the third embodiment is different from the server device 10 according to the first embodiment in that the storage unit 12 further stores a recognition model 12f and that the control unit 13 further includes a speech recognition unit 13g. Furthermore, the server device 10B is different from the server device 10 in that a terminal device 100B includes a microphone 101.

The recognition model 12f is a recognition model for speech recognition and the like in an automatic speech recognition (ASR) process.

The speech recognition unit 13g acquires, via the communication unit 11, speech data of a question to the user U input to the terminal device 100B via the microphone 101. In addition, the speech recognition unit 13g performs the ASR processing using the recognition model 12f on the acquired speech data, and converts the speech data into a text as a question text. Furthermore, the speech recognition unit 13g outputs the question text to the input text analysis unit 13b.

The input text analysis unit 13b performs the natural language process on the input text (here, the question text) and structures it in the same manner as before. Then, the input text analysis unit 13b extracts the question content from the result after the structuring, and causes the acquisition unit 13a to acquire past information related to the question content.

Then, the acquisition unit 13a outputs the acquired past information to the past information analysis unit 13c, the past information analysis unit 13c analyzes and structures the past information, and the contradiction degree determination unit 13d compares the structured question text with the past information to determine the degree of contradiction.

Then, as illustrated in FIG. 41, the generation unit 13e of the server device 10B includes the contradiction information generation unit 13eb and a response draft generation unit 13ee. The response draft generation unit 13ee generates a candidate for a response sentence to the question so that there is no contradiction with the past information based on the determination result by the contradiction degree determination unit 13d, the structured information 12b, and the like.

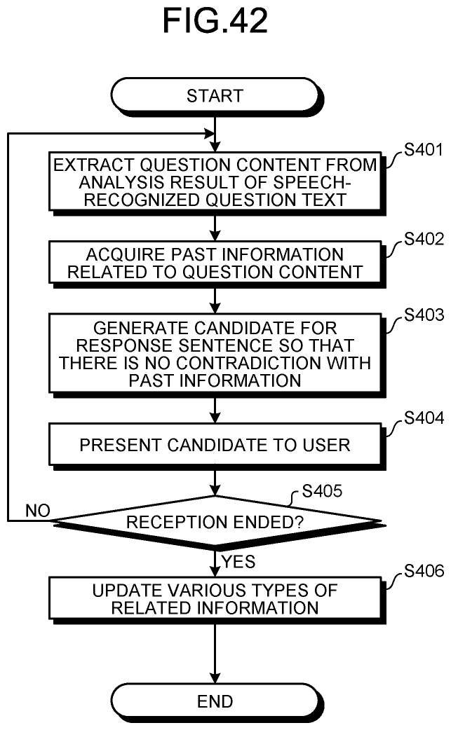

Next, a processing procedure executed by the server device 10B according to the third embodiment will be described with reference to FIG. 42. FIG. 42 is a flowchart illustrating a processing procedure executed by the server device 10B according to the third embodiment.

As illustrated in FIG. 42, the input text analysis unit 13b extracts the question content from the analysis result of the speech-recognized question text (step S401). Then, the acquisition unit 13a acquires past information related to the question content (step S402).

Then, based on the acquired past information, the response draft generation unit 13ee generates a candidate for a response sentence so that there is no contradiction with the past information (step S403). Then, the presentation unit 13f presents the generated candidate to the user U (step S404).

Then, it is determined whether acceptance of a question has ended (step S405). When the reception is not ended (step S405, No), the process from step S401 is repeated. When the reception ends (step S405, Yes), various types of related information are updated (step S406), and the process ends.

### 9-2. Specific Example of Information Processing According to Third Embodiment

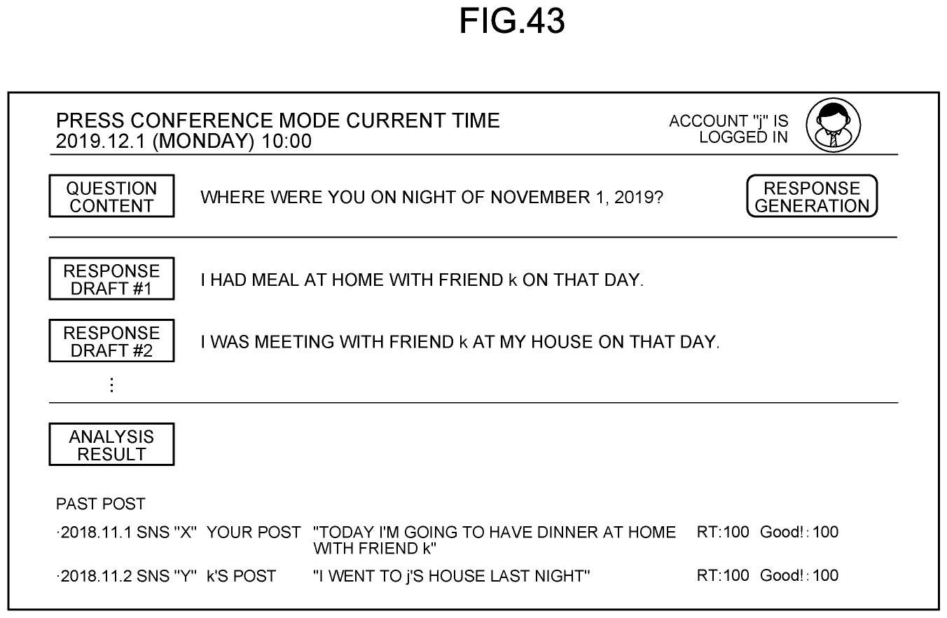

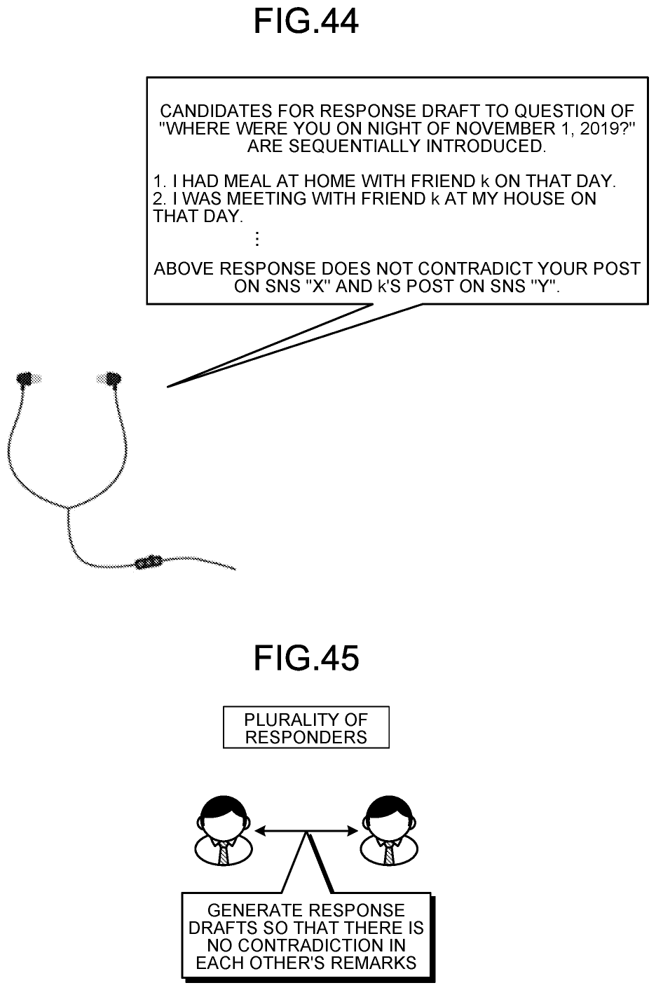

Next, a specific example of information processing according to the third embodiment will be described with reference to FIGS. 43 to 45. FIG. 43 is a diagram illustrating a display screen example of information processing according to the third embodiment. Furthermore, FIG. 44 is a diagram illustrating a presentation example by audio reproduction of information processing according to the third embodiment. Furthermore, FIG. 45 is an explanatory diagram in a case where there is a plurality of responders.

As illustrated in FIG. 43, for example, in a case where a response draft is presented by display on the screen, “QUESTION CONTENT” extracted by the input text analysis unit 13b can be first presented by the presentation unit 13f. Then, for example, when the user U operates a “RESPONSE GENERATION” button, respective response drafts generated so that there is no contradiction with the past information and “ANALYSIS RESULT” are displayed. In “ANALYSIS RESULT”, past posts that are basis, and the like are presented.

Note that “QUESTION CONTENT”, respective response drafts, “ANALYSIS RESULT”, and the like may be automatically presented each time a question is received without operating the “RESPONSE GENERATION” button. As a result, the user U who is a responder can quickly obtain an answer suitable for a question in a press conference, an interview, or the like where real-time property is required. Furthermore, in a case where the user U can answer a question without a response draft, the user U may glance over the presented response draft. Even in a case where the “RESPONSE GENERATION” button is operated, the user U may operate the “RESPONSE GENERATION” button only for a question that is difficult to reply.

Note that the degree of seriousness may be determined by sensing the number of people in the venue, a theme, and the like by using images, sounds, and the like.

Furthermore, as illustrated in FIG. 44, an earphone or the like may be worn by the user U, and a response draft or the like may be presented by audio reproduction. Such an example is useful, for example, in a situation where it is unnatural for the user U to response to a question while viewing the screen.

Furthermore, as illustrated in FIG. 44, in a case where there is a plurality of responders in a joint press conference or the like, exchanges with other responders may be acquired as past information, and respective response drafts may be generated so that there is no contradiction in each other's remarks.

<<10. Summary of Third Embodiment>>

As described above, according to the third embodiment of the present disclosure, the server device 10B (corresponding to an example of the “information processing apparatus”) further includes the speech recognition unit 13g that performs speech recognition on a speech-input question to the user U and converts the question into a text as a question text, wherein the input text analysis unit 13b analyzes the question text by the natural language process to extract a question content, the past information analysis unit 13c acquires the past information related to the question content to analyze the past information by the natural language process, and the generation unit 13e generates a candidate for a response sentence to the question so that there is no contradiction with the past information based on a comparison between respective analysis results of the input text analysis unit 13b and the past information analysis unit 13c.

<<11. Other Modifications>>

Note that, in each of the above-described embodiments, the description has been made by mainly exemplifying the case where the user U is a real person, but the present invention is not limited thereto, and the user U may be a fictitious existence, for example, a fictitious character appearing in an animation or the like. In this case, the scheduled remark text of the user U may be input by the account operator of the account corresponding to the user U who becomes a character in the animation world and remarks so as not to lose the world view of the animation. Furthermore, it may be generated by an artificial intelligence (AI) Bot, an SNS Bot, or the like that behaves as a character of the user U. Therefore, the past information about the user U is not limited to that of the real world, and may include past remarks, past behavior, incidents, knowledge, and the like in the fictitious world.

Further, in the above embodiments, it is also possible to manually perform all or part of the process described as being performed automatically of respective processes described, alternatively, it is also possible to automatically perform all or part of the process described as being performed manually by a known method. In addition, the processing procedure, specific name, and information including various pieces of data and parameters illustrated in the above document and drawings can be arbitrarily changed unless otherwise identified. For example, the various types of information illustrated in each figure are not limited to the illustrated information.

Further, each component of each of the illustrated devices is a functional concept, and does not necessarily have to be physically configured as illustrated in the figure. That is, the specific form of distribution/integration of each device is not limited to the one illustrated in the figure, and all or part of the device can be functionally or physically dispersed/integrated in any unit according to various loads and usage conditions. For example, the input text analysis unit 13b and the past information analysis unit 13c illustrated in FIG. 3 and the like may be integrated. Furthermore, for example, the acquisition unit 13a and the speech recognition unit 13g illustrated in FIG. 40 may be integrated.

In addition, some or all of the functions executed by the control unit 13 of the server device 10, 10A, 10B illustrated in FIG. 3 and the like may be executed by the terminal device 100. For example, the function of the speech recognition unit 13g may be implemented in the terminal device 100B, and the terminal device 100B may transmit the question text converted into a text to the server device 10B. In such a case, for example, even in a case where it is difficult for the server device 10B to clearly acquire the speech data due to deterioration of the communication state, it is possible to accurately proceed with the analysis of the question content and the like.

Further, the above-described embodiments can be appropriately combined in an area where the processing contents do not contradict each other. Further, the order of each step illustrated in the sequence diagram or the flowchart of the present embodiment can be changed as appropriate.

<<12. Hardware Configuration>>

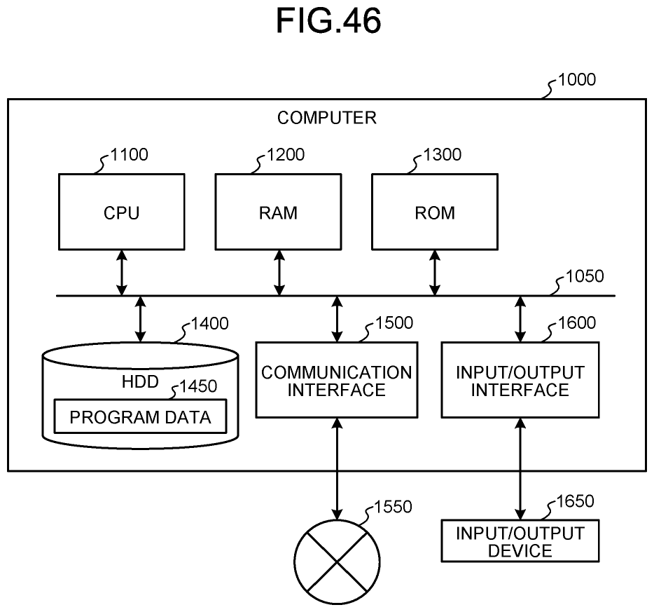

The information devices such as the server devices 10, 10A, and 10B and the terminal devices 100, and 100B according to respective embodiments described above are realized by a computer 1000 having a configuration as illustrated in FIG. 46, for example. Hereinafter, the server device 10 according to the first embodiment will be described as an example. FIG. 46 is a hardware configuration diagram illustrating an example of the computer 1000 that implements the functions of the server device 10. The computer 1000 includes a CPU 1100, a RAM 1200, a ROM 1300, a hard disk drive (HDD) 1400, a communication interface 1500, and an input/output interface 1600. Respective units of the computer 1000 are connected by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records programs executed by the CPU 1100, data used by the programs, and the like. Specifically, the HDD 1400 is a recording medium that records an information processing program according to the present disclosure which is an example of program data 1450.

The communication interface 1500 is an interface for the computer 1000 to be connected to an external network 1550 (for example, the Internet). For example, the CPU 1100 receives data from another device or transmits data generated by the CPU 1100 to another device via the communication interface 1500.

The input/output interface 1600 is an interface that connects an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the server device 10 according to the embodiment, the CPU 1100 of the computer 1000 executes the information processing program loaded on the RAM 1200 to implement the functions of the acquisition unit 13a, the input text analysis unit 13b, the past information analysis unit 13c, the contradiction degree determination unit 13d, the generation unit 13e, the presentation unit 13f, and the like. In addition, the HDD 1400 stores the information processing program according to the present disclosure and data in the storage unit 12. The CPU 1100 reads the program data 1450 from the HDD 1400 and executes the program data, but as another example, the program may be acquired from another device via the external network 1550.

<<13. Conclusion>>

The embodiments of the present disclosure have been described above, the technical scope of the present disclosure is not limited to the above-described embodiments as they are, and various changes can be made without departing from the gist of the present disclosure. Moreover, the components over different embodiments and modifications may be suitably combined.

Further, the effects in each embodiment described in the present specification are merely examples and are not limited, and other effects may be present.

The present technology may also be configured as below.

(1)

An information processing apparatus comprising:

an acquisition unit that acquires a text related to a remark of a user who has refrained from sending the remark;

a first analysis unit that analyzes, by a natural language process, the text related to the remark acquired by the acquisition unit;

a second analysis unit that analyzes past information about a content of the remark by the natural language process; and

a generation unit that generates a candidate for a remark text sent by the user so that there is no contradiction between the candidate and the past information based on a comparison between respective analysis results of the first analysis unit and the second analysis unit.

(2)

The information processing apparatus according to (1), further comprising:

a contradiction degree determination unit that determines a degree of contradiction with the past information based on a comparison between respective analysis results of the first analysis unit and the second analysis unit.

(3)

The information processing apparatus according to (2), wherein

the contradiction degree determination unit

calculates a difference between evaluation values, for a same object, included in respective analysis results of the first analysis unit and the second analysis unit, and determines that there is a contradiction when the difference is a predetermined amount or more.

(4)

The information processing apparatus according to (2) or (3), wherein

the contradiction degree determination unit

determines that there is a contradiction when temporal ranges indicated by temporal elements included in respective analysis results of the first analysis unit and the second analysis unit do not overlap.

(5)

The information processing apparatus according to any one of (2) to (4), wherein

the contradiction degree determination unit

determines that there is a contradiction when positional ranges indicated by positional elements included in respective analysis results of the first analysis unit and the second analysis unit do not overlap.

(6)

The information processing apparatus according to any one of (2) to (5), wherein

the contradiction degree determination unit

determining that there is no contradiction when, although behavioral elements included in respective analysis results of the first analysis unit and the second analysis unit are different, one behavioral element is included in the other behavioral element.

(7)

The information processing apparatus according to any one of (1) to (6), further comprising:

a feature extraction unit that extracts a feature of the user based on the remark text sent by the user in a past.

(8)

The information processing apparatus according to (7), wherein

the feature extraction unit

calculates statistics of first-person expressions and/or ending expressions, of the user, included in the remark text, and wherein

the generation unit

generates a candidate for the remark text by preferentially using the first-person expressions and/or the ending expressions having a large number of times of use based on a calculation result by the feature extraction unit.

(9)

The information processing apparatus according to (7) or (8), wherein

the feature extraction unit

calculates statistics related to a reply tendency of the user, wherein

the generation unit

generates a candidate for the remark text so as to increase a matching degree with respect to the reply tendency based on a calculation result by the feature extraction unit when the remark text is a reply sentence.

(10)

The information processing apparatus according to any one of (7) to (9), wherein

the acquisition unit

periodically crawls and acquires the past information existing on a network, wherein

the second analysis unit

periodically analyzes the acquired past information, and wherein

the feature extraction unit

periodically extracts a feature of the user based on the acquired past information.

(11)

The information processing apparatus according to any one of (1) to (9), further comprising:

a situation determination unit that determines a situation at a time of the remark based on an analysis result by the first analysis unit.

(12)

The information processing apparatus according to (11), wherein

the situation determination unit

uses a determination model generated by learning based on data with which a degree of seriousness is associated for each topic indicated by the remark to determine the degree of seriousness as the situation.

(13)

The information processing apparatus according to (12), further comprising:

a presentation unit that presents a candidate for the remark text generated by the generation unit to the user, wherein

the presentation unit

makes a presentation to the user so that the remark in which a candidate for the remark text is preferentially used is made as the degree of seriousness is higher.

(14)

The information processing apparatus according to any one of (1) to (13), wherein

the second analysis unit

analyzes the past information in a case where another user having at least an effective attribute or an unfriendly attribute with respect to the user is set and the past information about an opinion of the another user regarding a content of the remark exists, and wherein

the generation unit

generates a candidate for the remark text for each of a case of conforming to and a case of not conforming to the opinion of the another user based on an analysis result by the second analysis unit.

(15)

The information processing apparatus according to any one of (1) to (14), further comprising:

a speech recognition unit that performs speech recognition on a speech-input question to the user and converts the question into a text as a question text, wherein

the first analysis unit

analyzes the question text by the natural language process to extract a question content, wherein

the second analysis unit

acquires the past information related to the question content to analyze the past information by the natural language process, and wherein

the generation unit

generates a candidate for a response sentence to the question so that there is no contradiction with the past information based on a comparison between respective analysis results of the first analysis unit and the second analysis unit.

(16)

The information processing apparatus according to any one of (1) to (15), wherein

the past information related to a content of the remark

is at least one of the remark text posted by the user in a past, information, about a past behavior of the user, in which the user and/or anyone/anything other than the user are information sources, and a Web article.

(17)

The information processing apparatus according to any one of (1) to (16), wherein

the user is a fictitious character.

(18)

The information processing method, comprising:

acquiring a text related to a remark of a user who has refrained from sending the remark;

analyzing the text related to the remark acquired by the acquiring by a natural language process;

analyzing past information about a content of the remark by the natural language process; and

generating a candidate for a remark text sent by the user so that there is no contradiction between the candidate and the past information based on a comparison between respective analysis results of analyzing the text related to the remark and analyzing the past information.

(19) A non-transitory computer-readable recording medium storing a program for causing a computer to execute

acquiring a text related to a remark of a user who has refrained from transmitting the remark,

analyzing the text related to the remark acquired by the acquiring by a natural language process,

analyzing past information about a content of the remark by the natural language process, and

generating a candidate of a remark text transmitted by the user so that there is no contradiction between the candidate and the past information based on a comparison between respective analysis results of analyzing the text related to the remark and analyzing the past information.

### REFERENCE SIGNS LIST

1 INFORMATION PROCESSING SYSTEM
10, 10A, 10B SERVER DEVICE
11 COMMUNICATION UNIT
12 STORAGE UNIT
12a PAST INFORMATION DB
12b STRUCTURED INFORMATION
12c FEATURE INFORMATION
12d SITUATION DETERMINATION MODEL
12e COMPETITOR INFORMATION
12f RECOGNITION MODEL
13 CONTROL UNIT
13a ACQUISITION UNIT
13b INPUT TEXT ANALYSIS UNIT
13ba FIRST STRUCTURING PROCESSING UNIT
13bb SITUATION DETERMINATION UNIT
13c PAST INFORMATION ANALYSIS UNIT
13ca SECOND STRUCTURING PROCESSING UNIT
13cb FEATURE EXTRACTION UNIT
13cc THIRD STRUCTURING PROCESSING UNIT
13d CONTRADICTION DEGREE DETERMINATION UNIT
13da IDENTIFICATION UNIT
13db BASIS EXTRACTION UNIT
13dc COMPETITOR COMPARISON UNIT
13e GENERATION UNIT
13ea TEXT DRAFT GENERATION UNIT
13eb CONTRADICTION INFORMATION GENERATION UNIT
13ec TEMPLATE GENERATION UNIT
13ed COMPETITOR OPINION REFLECTION UNIT
13ee RESPONSE DRAFT GENERATION UNIT
13f PRESENTATION UNIT
13g SPEECH RECOGNITION UNIT
100, 100B TERMINAL DEVICE

1. An information processing apparatus comprising:
an acquisition unit that acquires a text related to a remark of a user who has refrained from sending the remark;
a first analysis unit that analyzes, by a natural language process, the text related to the remark acquired by the acquisition unit;
a second analysis unit that analyzes past information about a content of the remark by the natural language process; and
a generation unit that generates a candidate for a remark text sent by the user so that there is no contradiction between the candidate and the past information based on a comparison between respective analysis results of the first analysis unit and the second analysis unit.

2. The information processing apparatus according to claim 1, further comprising:
a contradiction degree determination unit that determines a degree of contradiction with the past information based on a comparison between respective analysis results of the first analysis unit and the second analysis unit.

3. The information processing apparatus according to claim 2, wherein
the contradiction degree determination unit
calculates a difference between evaluation values, for a same object, included in respective analysis results of the first analysis unit and the second analysis unit, and determines that there is a contradiction when the difference is a predetermined amount or more.

4. The information processing apparatus according to claim 2, wherein
the contradiction degree determination unit
determines that there is a contradiction when temporal ranges indicated by temporal elements included in respective analysis results of the first analysis unit and the second analysis unit do not overlap.

5. The information processing apparatus according to claim 2, wherein
the contradiction degree determination unit
determines that there is a contradiction when positional ranges indicated by positional elements included in respective analysis results of the first analysis unit and the second analysis unit do not overlap.

6. The information processing apparatus according to claim 2, wherein
the contradiction degree determination unit
determining that there is no contradiction when, although behavioral elements included in respective analysis results of the first analysis unit and the second analysis unit are different, one behavioral element is included in the other behavioral element.

7. The information processing apparatus according to claim 1, further comprising:
a feature extraction unit that extracts a feature of the user based on the remark text sent by the user in a past.

8. The information processing apparatus according to claim 7, wherein
the feature extraction unit
calculates statistics of first-person expressions and/or ending expressions, of the user, included in the remark text, and wherein
the generation unit
generates a candidate for the remark text by preferentially using the first-person expressions and/or the ending expressions having a large number of times of use based on a calculation result by the feature extraction unit.

9. The information processing apparatus according to claim 7, wherein
the feature extraction unit
calculates statistics related to a reply tendency of the user, wherein
the generation unit
generates a candidate for the remark text so as to increase a matching degree with respect to the reply tendency based on a calculation result by the feature extraction unit when the remark text is a reply sentence.

10. The information processing apparatus according to claim 7, wherein
the acquisition unit
periodically crawls and acquires the past information existing on a network, wherein
the second analysis unit
periodically analyzes the acquired past information, and wherein
the feature extraction unit
periodically extracts a feature of the user based on the acquired past information.

11. The information processing apparatus according to claim 1, further comprising:
a situation determination unit that determines a situation at a time of the remark based on an analysis result by the first analysis unit.

12. The information processing apparatus according to claim 11, wherein
the situation determination unit
uses a determination model generated by learning based on data with which a degree of seriousness is associated for each topic indicated by the remark to determine the degree of seriousness as the situation.

13. The information processing apparatus according to claim 12, further comprising:
a presentation unit that presents a candidate for the remark text generated by the generation unit to the user, wherein
the presentation unit
makes a presentation to the user so that the remark in which a candidate for the remark text is preferentially used is made as the degree of seriousness is higher.

14. The information processing apparatus according to claim 1, wherein
the second analysis unit
analyzes the past information in a case where another user having at least an effective attribute or an unfriendly attribute with respect to the user is set and the past information about an opinion of the another user regarding a content of the remark exists, and wherein
the generation unit
generates a candidate for the remark text for each of a case of conforming to and a case of not conforming to the opinion of the another user based on an analysis result by the second analysis unit.

15. The information processing apparatus according to claim 1, further comprising:
a speech recognition unit that performs speech recognition on a speech-input question to the user and converts the question into a text as a question text, wherein
the first analysis unit
analyzes the question text by the natural language process to extract a question content, wherein
the second analysis unit
acquires the past information related to the question content to analyze the past information by the natural language process, and wherein
the generation unit
generates a candidate for a response sentence to the question so that there is no contradiction with the past information based on a comparison between respective analysis results of the first analysis unit and the second analysis unit.

16. The information processing apparatus according to claim 1, wherein
the past information related to a content of the remark
is at least one of the remark text posted by the user in a past, information, about a past behavior of the user, in which the user and/or anyone/anything other than the user are information sources, and a Web article.

17. The information processing apparatus according to claim 1, wherein
the user is a fictitious character.

18. The information processing method, comprising:
acquiring a text related to a remark of a user who has refrained from sending the remark;
analyzing the text related to the remark acquired by the acquiring by a natural language process;
analyzing past information about a content of the remark by the natural language process; and
generating a candidate for a remark text sent by the user so that there is no contradiction between the candidate and the past information based on a comparison between respective analysis results of analyzing the text related to the remark and analyzing the past information.
